(19) United States
(12) Patent Application Publication
(10) Pub. No.: US 2013/0204690 A1
(43) Pub. Date: Aug. 8, 2013

(54) DETERMINING COUPON REDEMPTION VALIDITY VIA MOBILE DEVICES

(71) Applicant: Brad Liebmann, London (GB)

(72) Inventor: Brad Liebmann, London (GB)

(73) Assignee: GEOCAST HOLDINGS LIMITED, London (GB)

(21) Appl. No.: 13/879,336

(22) PCT Filed: Oct. 12, 2011
(86) PCT No.: PCT/US11/56037

§ 371 Date: Apr. 12, 2013

Related U.S. Application Data
(60) Provisional application No. 61/392,473, filed on Oct. 12, 2010.

(51) Int. Cl. G06Q 30/02

(52) U.S. Cl. CPC G06Q 30/0225
USPC 705/14.26

(57) ABSTRACT

Techniques are described for automatically determining validity of redeeming a coupon for a transaction, such as to allow a mobile device to receive and redeem electronic coupons for use in a non-electronic consumer transaction at a physical location of the merchant. The mobile device or a remote coupon server may identify electronic coupons responsive to the location of the mobile device and responsive user selections entered into the mobile device, and approve and redeem electronic coupons responsive to a determined redemption confidence score that reflects risk that locations and users may be misidentified and/or that coupons may be applied incorrectly or fraudulently. In some situations, the determination of validity of redeeming a coupon for a transaction at a physical location of a merchant is performed without any information from or other interactions with any personnel of the merchant or with any other electronic devices at the merchant's location.

### CROSS-REFERENCE TO RELATED APPLICATIONS

This application claims the benefit of provisional U.S. Patent Application No. 61/392,473, filed Oct. 12, 2010 and entitled “Systems, Program Product, And Methods To Deliver And Redeem Coupons With A Mobile Device,” which is hereby incorporated by reference in its entirety.

### BACKGROUND

Paper-based coupons are frequently used by consumers in order to receive discounts with respect to a given product available for purchase at a given merchant. Such coupons are, conventionally, provided by the consumer, i.e., redeemed, to the merchant in person. The merchant will then save the coupons received, and once a batch of coupons has been accumulated, the merchant will post the coupons, in batch, to a clearing house. At the clearing house, the coupons can be scanned and recorded so that a issuer of the coupons can compensate the merchant for the coupons posted.

There are several disadvantages, however, associated with the use of paper-based coupons. For the merchants, the disadvantages include (i) the manual, labor-intensive process of collecting, recording, and posting to a clearing house of the paper-based coupons; (ii) the lengthy waiting period, which can be several weeks, for the merchant to be reimbursed by the issuer. For the clearing house and issuer, the disadvantages include: (i) the labor-intensive process of manually scanning by a human each coupon posting, (ii) the potential for coupon mis-redemption, whereby coupons are posted by the merchant with respect to products that a consumer did not purchase in accordance with the coupon terms; and (iii) coupon mal-redemption, whereby merchants post coupons with respect to products that were not part of an actual consumer transaction. Coupon mis-redemption and mal-redemption are often difficult to detect without real time information and present an ever-present risk that coupon issuers may pay more to merchants than they should, had the coupons been validly redeemed.

Prior attempts to deliver and redeem coupons using mobile devices have relied upon some type of interaction between a mobile client device and local computer systems installed at the merchant location. Such local computer systems of a merchant may include, for example, Electronic Point of Sale (EPOS) systems, debit and credit card processing terminals, and software applications running on smartphones. Many of such local computer systems have been configured to read bar codes, QR codes (meaning “Quick Response codes”), or some other form of code that can be presented by the mobile client device and scanned at the local computer system using some sort of scanning device. Such local computer systems have been implemented for processing transaction information or communicating in real time with a remote coupon-processing server for processing the transaction.

There are also several disadvantages, however, associated with the use of such local computer systems. For the merchants, the disadvantages include: (i) the need to install local hardware to run software applications for redeeming coupons; (ii) the need to configure existing local hardware (e.g., EPOS systems) to interoperate with customers' mobile client devices; and (iii) the need to configure existing hardware to interoperate with third-party local systems (e.g., credit card processing terminal or smartphones), i.e., to transmit transaction data across a third party communications network for processing. Such systems have struggled to gain widespread acceptance for reasons including the high cost of such installation, configuration, or usage rates for such third-party communications networks.

### BRIEF DESCRIPTION OF THE DRAWINGS

FIG. 1 is a schematic drawing showing an architecture for use in one or more embodiments.

FIGS. 2A-2E illustrate an example embodiment of a routine for use in one or more embodiments.

FIG. 3 is a schematic drawing and flowchart for use in one or more embodiments.

FIG. 4 is a schematic drawing and flowchart for use in one or more embodiments.

FIG. 5 is a schematic drawing and flowchart for use in one or more embodiments.

FIG. 6 is a schematic drawing and flowchart for use in one or more embodiments.

FIG. 7 is a schematic drawing and flowchart for use in one or more embodiments.

FIG. 8 is a schematic drawing and flowchart for use in one or more embodiments.

FIG. 9 is a schematic drawing and flowchart for use in one or more embodiments.

FIG. 10 is a database diagram showing data structures of a client database or a server database for use in one or more embodiments.

FIG. 11 is a schematic drawing for use in one or more embodiments.

FIG. 12 is a schematic drawing for use in one or more embodiments.

FIG. 13 is a schematic drawing for use in one or more embodiments.

FIG. 14 is a screenshot showing one or more example displays on a mobile device for use in one or more embodiments.

FIG. 15 is a screenshot showing one or more example displays on a mobile device according to for use in one or more embodiments.

FIG. 16 is a screenshot showing one or more example displays on a mobile device according to for use in one or more embodiments.

FIG. 17 is a screenshot showing one or more example displays on a mobile device according to for use in one or more embodiments.

FIG. 18 is a screenshot showing one or more example displays on a mobile device according to for use in one or more embodiments.

FIG. 19 is a screenshot showing one or more example displays on a mobile device according to for use in one or more embodiments.

FIG. 20 is a screenshot showing one or more example displays on a mobile device according to for use in one or more embodiments.

FIG. 21 is a screenshot showing one or more example displays on a mobile device according to for use in one or more embodiments.

FIG. 22 is a screenshot showing one or more example displays on a mobile device according to for use in one or more embodiments.

FIG. 23 is a screenshot showing one or more example displays on a mobile device according to for use in one or more embodiments.

### DETAILED DESCRIPTION

The terms “user” and “consumer” are used interchangeably herein, and each refers generally to a human, such as an owner and/or operator of a mobile device used in the manners described herein.

The term coupon “mis-redemption” refers generally herein to an event in which a consumer presents to a merchant a coupon that is actually invalid for a particular transaction, but the merchant nonetheless accepts it. Coupons may be invalid or otherwise inapplicable for use with a transaction for various reasons; for example, the terms and conditions on the coupon may specify one particular product or pack size, but the consumer does not purchase that particular product or pack size, the coupon may be out of date; or the consumer may be attempting to redeem more than one coupon when the terms and conditions limit the use of the coupon to only one per shop or per household. Such coupon mis-redemption may be perpetrated by a consumer alone, or also by a consumer in collaboration with a merchant.

The term coupon “mal-redemption” refers generally herein to an event in which a merchant, or an entity posing as a merchant, fraudulently redeems or attempts to fraudulently redeem a coupon for an item without relation to an actual underlying transaction occurring. For example, a merchant may cut out a large volume of coupons from unsold newspapers and post such coupons to a coupon clearing house in an attempt to redeem the face value and trade-handling allowance of such coupons.

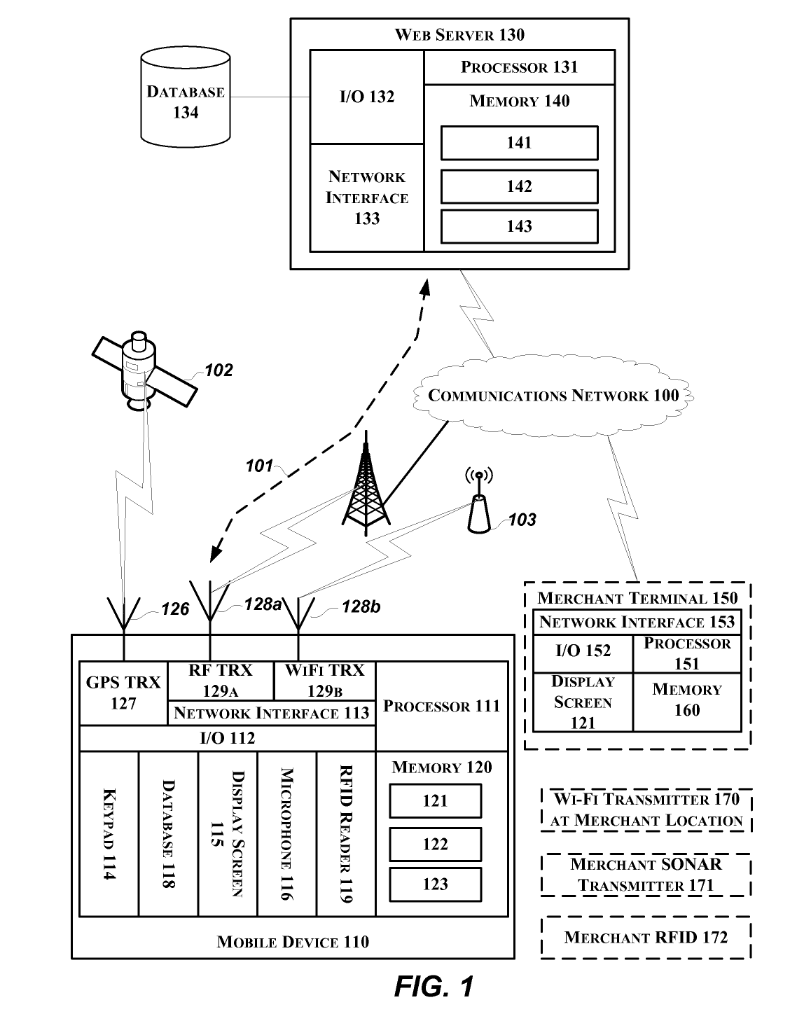

FIG. 1 is a schematic drawing showing an architecture for use in one or more embodiments. In particular, various of the illustrated devices and modules may be part of a coupon redemption system that operates to automatically determine the validity of redeeming a particular coupon for a particular transaction involving a user of a mobile device and a merchant, such as one or more of software modules 121, 122 and 123 of mobile device 110 and/or one or more of software modules 141, 142 and 143 of coupon server computing system 130, although in other embodiments other architectures may be used. The automated determination of the validity of redeeming a coupon for a transaction may be performed, for example, in response to the performance of the transaction, to an attempt to perform the transaction, or to an indication of interest in potentially performing the transaction. In addition, in at least some embodiments, the automated determination of the validity of redeeming a coupon for a transaction may include generating or otherwise determining one or more redemption confidence scores corresponding to the validity of redeeming the coupon for the non-electronic transaction, as discussed in greater detail below.

A mobile device 110 is shown with respect to FIG. 1. The terms “mobile device,” “mobile computing device”, “mobile client device”, “communication device,” “wireless device,” “wireless telephone,” “wireless communications device,” “wireless communication system,” “device” and “wireless handset” are used interchangeably herein. A mobile device may be, for example, a cellular telephone, a pager, a personal digital assistant (“PDA”), a smartphone, a navigation device, or other mobile personal computer capable of making a wireless (e.g., Wi-Fi, cellular, etc.) connection (e.g., a laptop, a tablet, etc.).

According to one embodiment, device 110 may be a smartphone, which may include the functionality of a standard mobile telephone as well as the functionality of a handheld personal computer, for example, having any of the following capabilities: web browsing, personal data applications (e.g., email, calendar, contacts, and so on), database, word processing, and spreadsheets. Device 110 may also have the ability to determine its geographic location using location-identifying techniques that will be known to those having skill in the art, such as Global Positioning System (GPS), near field communications (NFC), and cell tower identification, for example.

Referring to FIG. 1, program products 121, 122, and 123 are software modules available for local execution on the device 110 (e.g., as part of a third-party application that is downloaded by the user onto the smartphone). In other embodiments, program products 141, 142, and 143 on the server 130 may perform some or all of the described techniques, and may communicate with an interface on the mobile device 110.

As is shown with reference to FIG. 1, device 110 may include one or more processors 111 (e.g., one or more microprocessors, microcontrollers, and other analog and/or digital circuit components configured to perform the functions described herein). The processor 111 is the “brains” of the device 110, and as such executes computer program product or products, such as the client update module 121, the coupon delivery module 122, and the coupon redemption module 123, and works in conjunction with the I/O 112 to direct data to a non-transitory memory 120 and to send data or commands from the non-transitory memory 120 to the database 118, and the network interface 113, and peripherals or installed components such as keypad 114, display screen 115, microphone 116, GPS transceiver 127, and RFID Reader 119. The processor 111 may be any commercially available processor, or plurality of processors, adapted for use in or with the device 110, e.g., ARM Cortex-A8, Qualcomm MSM7201A, Intel XScale PXA270, or Texas Instruments OMAP3430. Processor 111 may also be selected from Intel® Xeon® multicore processors, Intel® micro-architecture Nehalem, and AMD Opteron™ multicore processors. In one embodiment, processor 111 may comprise a first applications microprocessor configured to run a variety of personal information management applications, such as email, a calendar, contacts, etc., and a second, radio processor on a separate chip or as part of a dual-core chip with the application processor. The radio processor may be configured to operate telephony functionality. Mobile device 110 may be configured for wireless communications using any of the technologies described herein. As one skilled in the art will appreciate, processor 111 may also include components that allow the device 110 to be connected to a display, as will be understood by those skilled in the art, and keyboard or other peripherals that would allow a user to directly or indirectly access the processor 111 and non-transitory memory 120.

As is shown with reference to FIG. 1, device 110 may further include a non-transitory memory 120 or more than one non-transitory memories. Non-transitory memory 120 is configured to store a computer program product or products comprising instructions for execution on the processor 111. Non-transitory memory 120 includes both non-volatile memory, e.g., hard disks, flash memory, optical disks, and the like, and volatile memory, e.g., SRAM, DRAM, and SDRAM. As one skilled in the art will appreciate, though the non-transitory memory 120 is depicted on, e.g., a motherboard, of the device 110, the non-transitory memory 120 may also be a separate component or device, e.g., flash memory, connected to the device 110 through the I/O 112. For example, a user may use a user interface to access applications and computer program products stored on the non-transitory memory 120 and run on the processor 111. As one skilled in the art will understand, the program product or products, along with one or more databases, data libraries, data tables, data fields, or other data records may be stored either in non-transitory memory 120 or in separate non-transitory memory 120, for example, associated with a storage medium such as database 118, positioned in communication with the device 110 through the I/O 112.

Non-transitory memory 120 may also include an operating system for operating the device 110, such as Symbian OS, Apple iOS, Blackberry OS, Android, Microsoft Windows CE, Microsoft Phone 7, or PalmOS. Non-transitory memory 120 may also include a suite of Internet tools including a web browser (such as Safari or Opera Mini), including a web browser having support for third-party applications.

Device 110 may further include a transceiver 129 having analog, digital, or analog and digital electrical components configured to receive, transmit, or receive and transmit wireless signals via an antenna 128 for providing telephone communications or data communications with a fixed wireless access point, such as a cellular telephone tower. The telephone communications or data communications with a fixed wireless access point may be over a communications network such as those provided by a network carrier such as Verizon Wireless, Sprint, or AT&T, for example. Data communications may also be over a local area network, such as Ethernet, a network implemented according to an IEEE 802.11x standard, or a personal area network implemented using, for example, Bluetooth or infrared communication technology.

Device 110 may further include a Global Positioning System (GPS) transceiver 127, and the non-transitory memory 120 may include a location-determining module (software) for identifying the coordinates of the client and processing those coordinates into a form that may be passed to the client application and the server 130. The global position system transceiver 127 may be a commercially available device. As is well-known, GPS is currently the most precise positioning system generally available to the general public. The GPS comprises a network of satellites orbiting the earth. Each satellite transmits a ranging signal modulated on a 1.575 GHz carrier. By monitoring the signal from a plurality of satellites, GPS transceiver 127 may determine the device 110's position, i.e., latitude, longitude and altitude (e.g., to an accuracy of approximately 100 meters). “Differential GPS,” which is also known in the art, is more accurate than standard GPS and is also available to the public. Embodiments may include differential GPS transceivers as well.

A web coupon server 130 is shown with respect to FIG. 1. Device 110 and server 130 may communicate via a communication link 101 over communications network 100. Communications network 100 may be or include any public or private network, such as the public Internet, a private intranet, a virtual private network (VPN) tunneled across the public Intranet, for example, using a network security protocol, such as Netscape's Secure Socket Layer (SSL) protocol. Communications network 100 may be implemented over any of various wireless communication technologies, for example: code division multiplexed access (“CDMA”), time division multiplexed access (“TDMA”), frequency division multiplexed access (“FDMA”), orthogonal frequency division multiplexed access (“OFDMA”), global system for mobile communications (“GSM”), Analog Advanced Mobile Phone System (“AMPS”), Universal Mobile Telecommunications System (“UMTS”), 802.11a/b/g/n (“Wi-Fi”), World Interoperability for Microwave Access (“WiMAX”), or Bluetooth.

Web coupon server 130, as is shown with respect to FIG. 1, may include one or more processors 131 (e.g., one or more microprocessors, microcontrollers, and other analog and/or digital circuit components configured to perform the functions described herein). The processor 131 is the “brains” of the server 130, and as such executes computer program product or products and works in conjunction with the I/O 132 to direct data to a non-transitory memory 140 and to send data or commands from the non-transitory memory 140 to the database, the network interface 106, and the user interface 108. The processor 131 may be any commercially available processor, or plurality of processors, adapted for use in or with the server 130, e.g., Intel® Xeon® multicore processors, Intel® micro-architecture Nehalem, and AMD Opteron™ multicore processors.

As is shown with reference to FIG. 1, server 130 may further include a non-transitory memory 140 or more than one non-transitory memories. Non-transitory memory 140 is configured to store a computer program product or products comprising instructions for execution on the processor 131. Non-transitory memory 140 includes both non-volatile memory, e.g., hard disks, flash memory, optical disks, and the like, and volatile memory, e.g., SRAM, DRAM, and SDRAM. As one skilled in the art will appreciate, though the non-transitory memory 140 is depicted on, e.g., a motherboard, of the server 130, the non-transitory memory 140 may also be a separate component or device, e.g., flash memory, connected to the server 130 through the I/O 132. As one skilled in the art will understand, the program product or products, along with one or more databases, data libraries, data tables, data fields, or other data records may be stored either in non-transitory memory 140 or in separate memory (also non-transitory), for example, associated with a storage medium such as database 134, positioned in communication with the server 130 through the I/O 132. Non-transitory memory 140 may further include drivers, modules, libraries, or engines allowing server 130 to function as a web server or application server, such as a server-side markup language processor (e.g., a PHP processor) to interpret server-side markup language and generate dynamic web content (e.g., a web page document).

An embodiment of a system including both a client device 110 and a web server 130 is illustrated in FIG. 1. In one embodiment of the system, all, or as much of the processing as is practical, is performed by client device 110 instead of by server 130. The purpose of this is to enable client device 110 to execute program products, for example, to validate couponing transactions even if communications link 101 between the client device 110 and the server 130 is broken. Such an embodiment has several advantages, including: (i) the ability to authorize a couponing transaction at a merchant location where communications is not possible with server 130 (e.g., underground, inside a large building, in a “dead spot”); and (ii) enhanced transaction authorization speed. Speed of transactions may be beneficial for merchants, to prevent slowing checkout queues to unacceptable levels.

It will be appreciated that devices and systems 110, 130 and 150 are merely illustrative and are not intended to limit the scope of embodiments of the present disclosure. The modules 121-123 and/or 141-143 may instead each be executed by multiple interacting computing systems or devices, and one or more of the illustrated devices and systems of FIG. 1 may be connected to other devices that are not illustrated, including through one or more networks such as the Internet, via the World Wide Web (“Web”), or other electronic communications network (e.g., cellular based network, public switched telephone network, etc.). More generally, a computing system or computing device may comprise any combination of hardware and/or firmware that may interact in the described manners, optionally when programmed or otherwise configured with particular software, including (without limitation) desktop or other computers, network devices, PDAs, cell phones, wireless phones, pagers, electronic organizers, Internet appliances, television-based systems (e.g., using set-top boxes and/or personal/digital video recorders), game consoles, media players and various other consumer products that include appropriate inter-communication capabilities.

It will also be appreciated that, while various items are discussed or illustrated as being stored in memory or on storage while being used, these items or portions of them can be transferred between memory and other storage devices for purposes of memory management and data integrity. Alternatively, in other embodiments some or all of the software systems and/or modules may execute in memory on another device and communicate with the illustrated computing systems or devices via inter-computer communication. Furthermore, in some embodiments, some or all of the systems and/or modules may be implemented or provided in other manners, such as at least partially using firmware and/or hardware means, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the systems, modules and/or data structures may also be stored (e.g., as software instructions or structured data) on a non-transitory computer-readable storage medium, such as a hard disk or flash drive or other non-volatile storage device, volatile or non-volatile memory (e.g., RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

Web server 130 may include database 134, which is shown with reference to FIG. 1. The databases discussed herein, including database 134, may be, for example, any sort of organized collection of data in digital form. Databases may include a database management system (DBMS) consisting of software that operates the database, provides storage, access, security, backup and other facilities. DBMS may support multiple query languages, including, for example, SQL, XQuery, OQL, LINQ, JDOQL, and JPAQL. Databases may implement any known database model or database models, including, for example, a relational model, a hierarchical model, a network model, or an object-oriented model. The DBMS may include Data Definition Language (DDL) for defining the structure of the database, Data Control Language (DCL) for defining security/access controls, and Data Manipulation Language (DML) for querying and updating data. The DBMS may further include interface drivers, which are code libraries that provide methods to prepare statements, execute statements, fetch results, etc. Examples of interface drivers include ODBC, JDBC, MySQL/PHP, FireBird/Python. DBMS may further include a SQL engine to interpret and execute the DDL, DCL, and DML statements, which includes a compiler, optimizer, and executor. DBMS may further include engine a transaction engine to ensures that multiple SQL statements either succeed or fail as a group, according to application dictates. DBMS may further include a relational engine to implement relational objects such as Table, Index, and Referential integrity constraints. DBMS may further include a storage engine to store and retrieve data from secondary storage, as well as managing transaction commit and rollback, backup and recovery, etc.

Data stored in fields of the databases may be updated, for example, by a user with administrative access to the database to add new data to the libraries in the database as they become supported. It will be appreciated by those having skill in the art that data described herein as being stored in the databases may also be stored or maintained in non-transitory memory 140 or a non-transitory memory 120 of the client device 110 and accessed among subroutines, functions, modules, objects, program products, or processes for example, according to objects and/or variables of such subroutines, functions, modules, objects, program products or processes. Any of the fields of the records, tables, libraries, and so on of the database may be multi-dimensional structures resembling an array or matrix and may include values or references to other fields, records, tables, libraries, and so on so as to allow multiple values to be associated with a particular site attribute. Any of the foregoing fields may contain either actual values or a link, a join, a reference, or a pointer to other local or remote sources for such values. An illustrated database may be a single database, multiple databases, or a virtual database, including data from multiple sources, for example, servers on the world wide web.

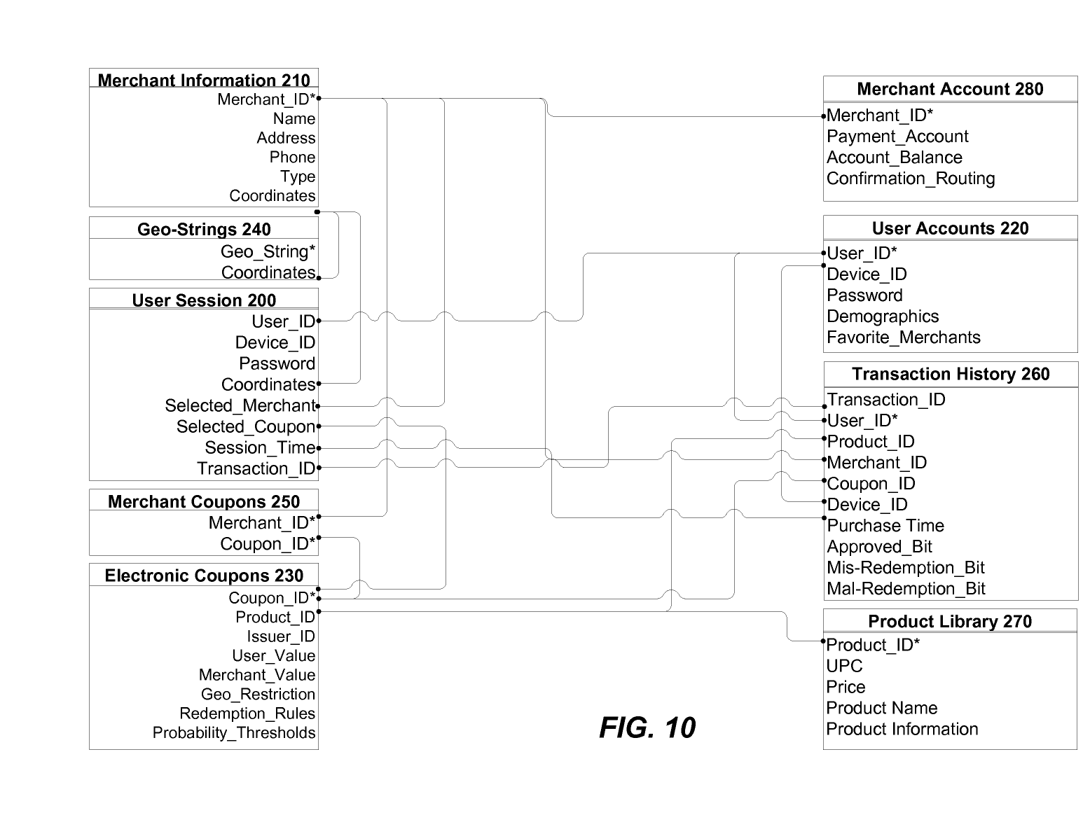

As may further be shown with reference to FIG. 10, database 134 may include a merchant accounts library 210 for matching the coordinates of a mobile device, such as those of device 110 to nearby merchant locations. Data in each unique entry of the merchant accounts library may include: unique merchant ID, merchant name, merchant address, merchant phone number, merchant type, and merchant location coordinates. Database 134 may include synchronization functionality for synchronizing the merchant accounts library 210 in with the client device 110 on a regular periodic basis, so that an identical merchant accounts library may be loaded onto the client device.

As may further be shown with reference to FIG. 10, database 134 may include a user accounts library 220 for matching the user of a mobile device, such as a user using device 110 to a user account on the server 130. Data in each unique entry of the user accounts library 220 may include: unique user ID, unique associated mobile device ID (where known), user password, and other identifying and demographic information for the user. The user accounts library 220 may also contain a field or a flag indicating whether transactions associated with the user account (i.e., user IDs or mobile device IDs) should not be processed.

As may further be shown with reference to FIG. 10, database 134 may include an electronic coupons library 230 for matching a product, such as a product being purchased by the user of device 110, to coupon information on the server 130. Data in each unique entry of the electronics coupons library 230 may include: a) a coupon ID (identifier); b) an SKU or other unique tracking number to which the coupon relates (e.g., Universal Product Code (UPC), European Article Number (EAN), Global Trade Item Number (GTIN) or Australian Product Number (APN)); the identity of the issuer of the coupon; c) the monetary value of the coupon to the consumer; d) the monetary value of the coupon to the local merchant; e) geographic region in which the coupon is valid; f) any rules provided for the valid redemption of the coupon (e.g., valid merchant locations, number of coupons available for redemption, time of day); and g) one or more probability thresholds associated with the coupon, such as for one or more of an L-probability, a U-probability, a C-probability, an M-probability, and a combined S-score, as discussed in greater detail below. Database 134 may have associated synchronization functionality for synchronizing the electronic coupons library 230 in with the client device 110 on a regular periodic basis, so that an identical electronic coupons library may be loaded onto the client device.

As may further be shown with reference to FIG. 10, database 134 may include a geo-strings library 240. Data in each unique entry of the geo-strings library 240 may include: geo-string locations (e.g., place names, postal codes) and identifying coordinates (such as latitude and longitude) for such locations.

### Update Modules 121 and 141

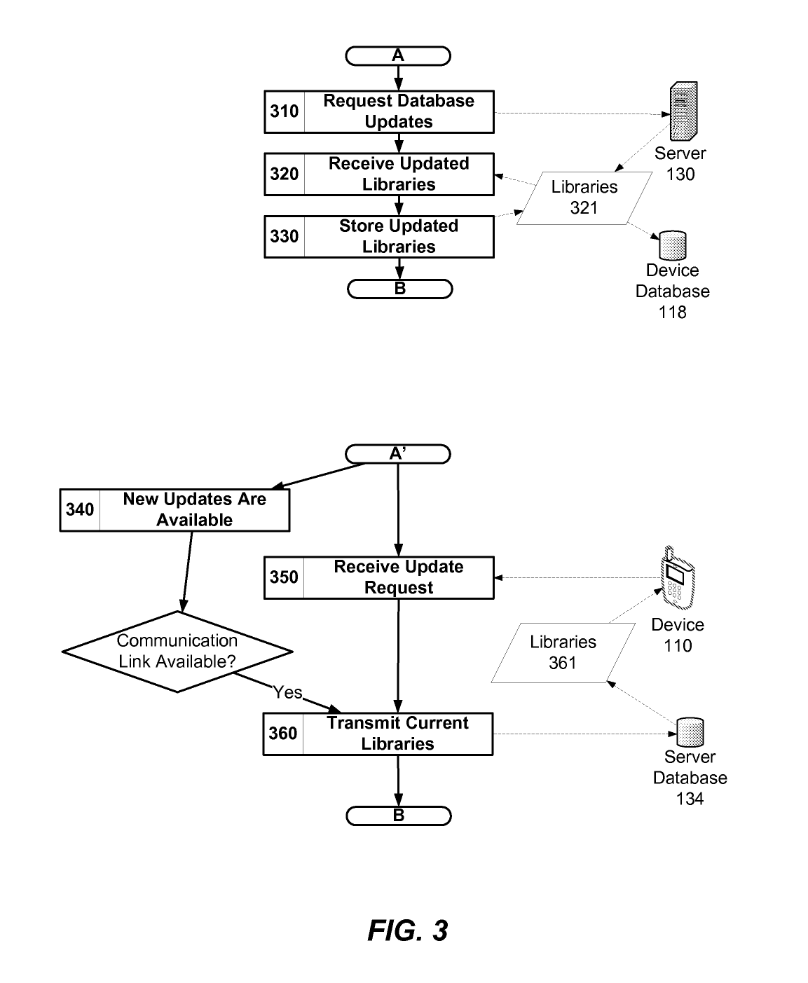

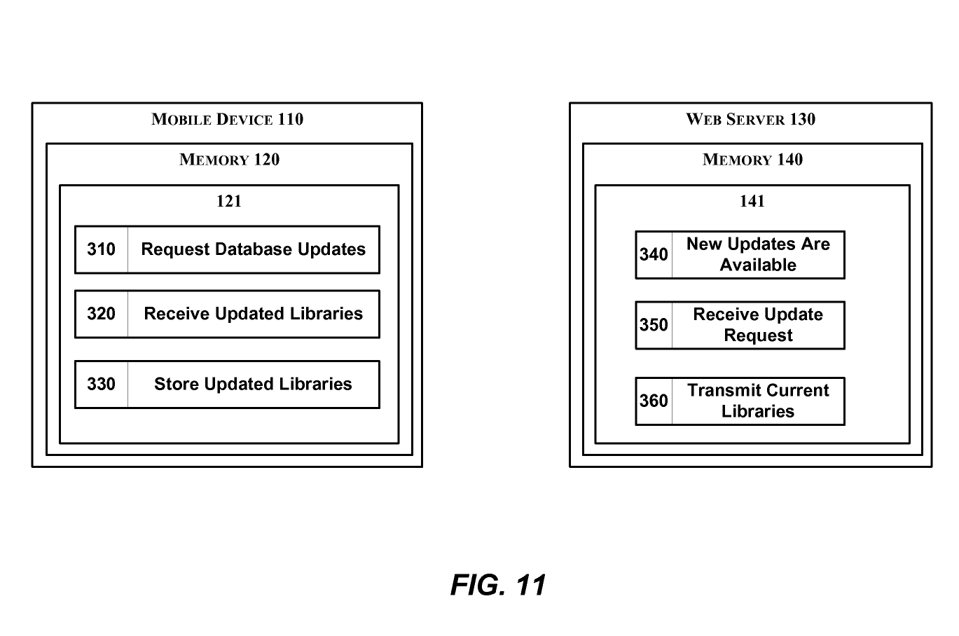

Update Modules 121 and 141, as are shown with reference to FIG. 11, are computer program products stored in a non-transitory memory and operable on a processor. An embodiment of the client update module 121 includes steps for implementing a periodic update to the libraries stored in the client database 118. Such updates are provided by the server 130 based on the libraries stored in the server database 134, and are designed to ensure that client device 110 is equipped with the up-to-date data for authorizing couponing transactions. Such updates are normally performed whenever a new update is available, device 110 is started by a user and communications link 101 is established. As is shown with reference to FIG. 3, when the client update module 121 is executed by the processor 111, the device 110 requests 310 database updates from the server 130. Responsive to transmission by server 130 of the current libraries 321, the device receives 320 the current libraries 321 and stores 330 the current libraries 321 in the device database 118.

An embodiment of the server update module 141 includes steps for implementing a periodic update to the client device 110 so that it may update its device database 118. Such updates are provided by the server 130 based on the libraries stored in the server database 134, and are designed to ensure that client device 110 is equipped with the up-to-date data for authorizing couponing transactions. Such updates may be provided, for example, whenever an instruction is received 340 at the server 130 that a new update is available (and a communication link to device 110 is available) or when requested by the client device 110. As is shown with reference to FIG. 3, when the server update module 141 is executed by the processor 131, server 130 receives 350 a requests for database updates from the device 110. Responsive to the update request, the server 130 transmits 360 the current libraries 361 stored at the server database 134 to the device 110.

In either embodiment of the client update module 121 or the server update module 141, the libraries to be updated may include, for example: (i) all or part of the merchant accounts library 210, including any changes to valid merchant coordinates; (ii) all or part of the electronic coupons library 230 and the merchants-coupons library 250, including any new or updated valid coupons, any updated restrictions for certain merchants, users, or mobile devices, or any updated probability rules; (iii) all or part of the geo-strings library 240; and (iv) all or part of the user accounts library 220 and the transaction history library 260, for example, only those entries pertaining to the user ID or the device ID for the particular user or client device 110. The outputs and results of the instructions being processed in the modules described herein are used to dynamically refresh the libraries described herein. Such updating provides constant and real time improvements to the outcomes that the system provides.

### Coupon Delivery Module 122

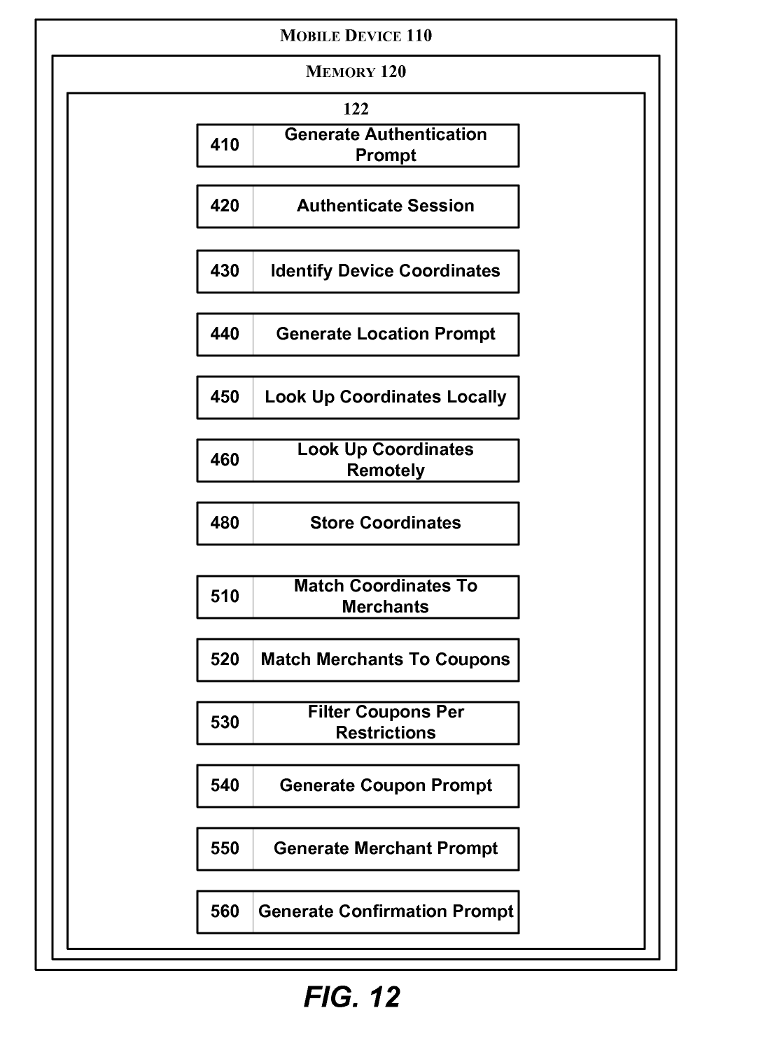

Coupon Delivery Module 122, as is shown with reference to FIG. 12 and FIG. 1, is a computer program product stored in a non-transitory memory and operable on a processor. When a client device 110 attempts to log into the server 130, an authentication session may be performed. Such authentication may be useful for a number of reasons, including: (i) if coupon-delivery module 122 is implemented as a browser-based application and there is no other way to identify the User_ID or Device_ID; and (ii) if the user has activated a client application with which a higher level of security is associated (e.g., the user has a subscription account against which coupons are redeemed. Once the user is authenticated, re-authentication may not be performed in the future as long as the Device_ID is recognized by the server 130.

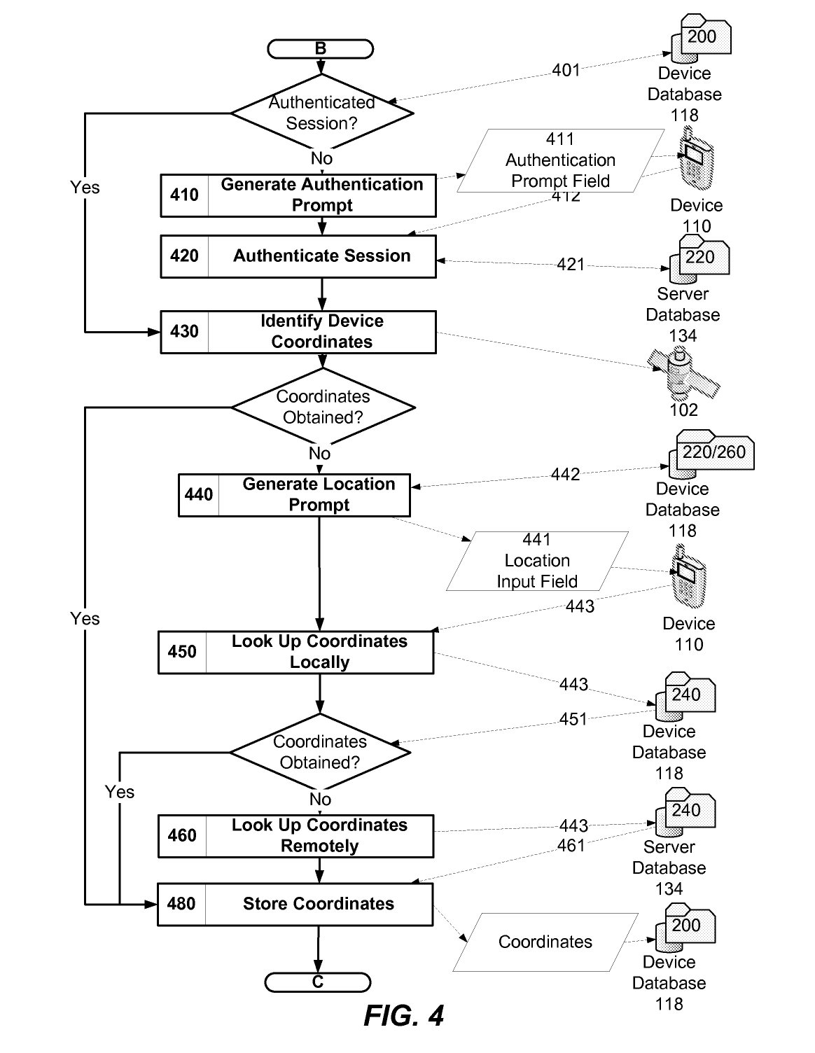

As is shown with respect to FIG. 4, the client device 110 may perform a check of session properties 401 to determine whether an authenticated session exists. Session properties 401 may include, for example, any of the properties in the user session table 200, such as fields Session_ID and Session_Time. An authenticated session may be determined, for example, when Session_ID or Session_Time are equal to a predefined value or are within a predefined range. If the authenticated session does not exist, the client device 110 may generate 410 an authentication prompt for display at the display screen 115 of the device 110. The authentication prompt may be displayed as an authentication prompt field 411, which may be, for example, one or more input fields. Input fields, as will be appreciated by those having skill in the art, may include input fields such as HTML FORM fields, or other types of input fields native to the operating system of device 110. Input fields, as will be appreciated by those having skill in the art, allow a user to input or select a value that is associated with a property or variable name. One or more input fields may be associated with a trigger, such as a submit button, so that a user may initiate the transmission the input or selected value, along with the property or variable name, to a software module so that the software module is able to associate the property or variable name with the value input or selected by the user. As will be appreciated by those having skill in the art, input fields may be configured to automatically transmit the value input or selected therein, for example, automatically upon entry by using client-side scripting techniques, such as those provided by JavaScript. Authentication prompt field 411 may include one or more input fields for a user name value and a user password value. Responsive to receiving an input or selection of a value or values 412, with respect to the authentication prompt field 411, the client device 110 may authenticate 420 the session by comparing user account properties 421, e.g., a user name value and the password value, to a User_ID and Password from the user account library from the user account library 220. If authentication succeeds, the client 110 may create and record new Session_ID in the user session table 200 and record the client's 110 system time as a Session_Time in the user session table 200.

After user authentication, the device 110 may then attempt to locate itself by identifying the geographic coordinates of the device 110. Various techniques may be used to determine the location of mobile device 110. Depending upon the specification of mobile device 110, such techniques may use software routines already resident upon the client device. As is shown with respect to FIG. 4, the client device 110 may use native GPS functionality to identify 430 its coordinates based on signals received from a satellite 102.

Another technique that client device 110 may use in some embodiments to locate its geographic coordinates is to search local wireless networks via a Wi-Fi receiver of the client device (e.g., transceiver 129b). By recognizing a network Wi-Fi transmitter device 170 at the location of a merchant, the client device 110 may identify its location based on identifying the device 170. For example, the device 170 may be a network Wi-Fi transmitter device that is specific to a coupon redemption system to which the coupon server 130 belongs and that transmits a specific MAC address unique to the specific merchant location, and the client device 110 may identify its 430 coordinates based on information stored by the coupon server 130 and/or client device 110 that associates the MAC address with the location of the merchant.

Other techniques by which client 110 may identify 430 its coordinates include the following:
Cell tower triangulation may be used to determine the location of mobile device 110, and such may be used independently or in tandem with the GPS. Conventional smartphones, for example, may perform such geo-location on using a native methods. Alternatively, device 110 may identify one or more cell tower IDs using native methods and then send the cell tower IDs to server 130, where server 130 may determine the coordinates of the cell tower IDs and responsively determine the coordinates of the device 110 using cell tower triangulation.
Near field communication (NFC), which is a highly precise method of locating mobile device 110, may be used to determine the location of device 110. NFC allows the user of mobile device 110 to wave the device near a unique RFID field installed at the merchant's premises. Referring to FIG. 1, the RFID receiver 119 in mobile device 110 may detect the RFID field and then cross references the identifying RFID string to the coordinates of the merchant, for example, using the RFID_String and Coordinates fields in the merchant information library 210.
Sound transmission is also a precise method of locating mobile device 110. Referring to FIG. 1, the microphone 116 in mobile device 110 may detect a specific sound frequency emitted at the merchant's premises, for example by SONAR transmitter 171. Device 110 may then cross reference the identifying sound frequency to the coordinates of the merchant, for example, using the Frequency_ID and Coordinates fields in the merchant information library 210.
WLAN. Referring to FIG. 1, mobile device 110 may recognize local wireless networks via Wi-Fi receiver 129b. Through recognizing these networks, identifying details about the network including (but not limited to) the MAC address(es) that are detected, such identifying details may be used to identify a network with a specific merchant location or may be used to triangulate such a location using a third party service for such. The application uses the identifying details to locate the device 110. It should be noted such networks may or may not be encrypted.
Browser Cookie. Mobile application may set a browser cookies with the device allowing future application activities to reference these cookies to allow such features as user identification, historical location activity, historical transaction locations and preferences.

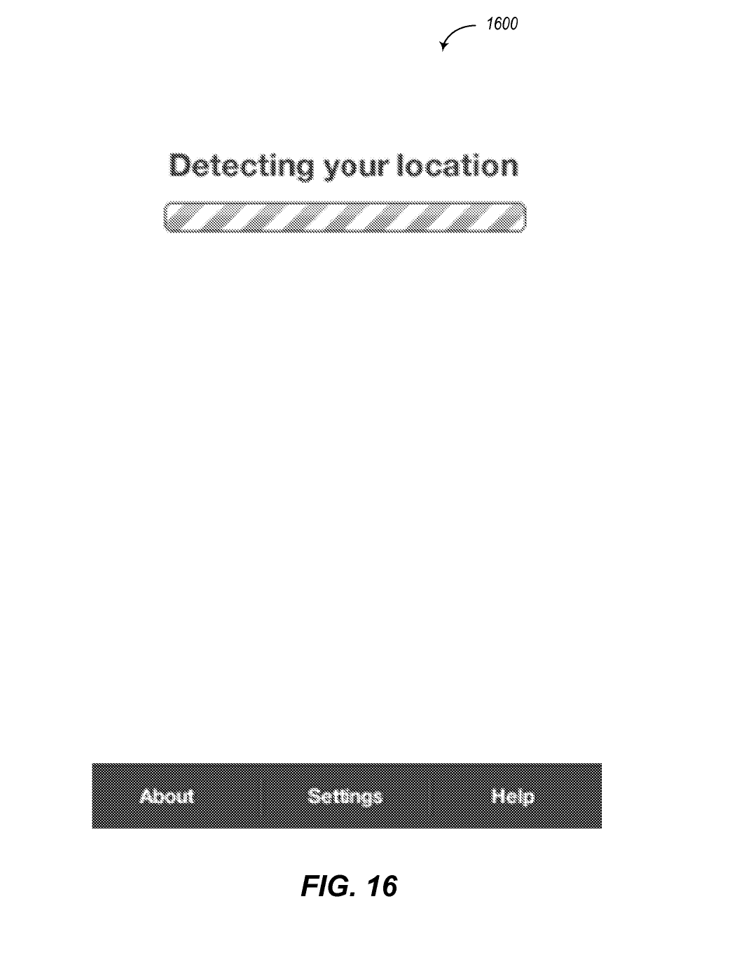

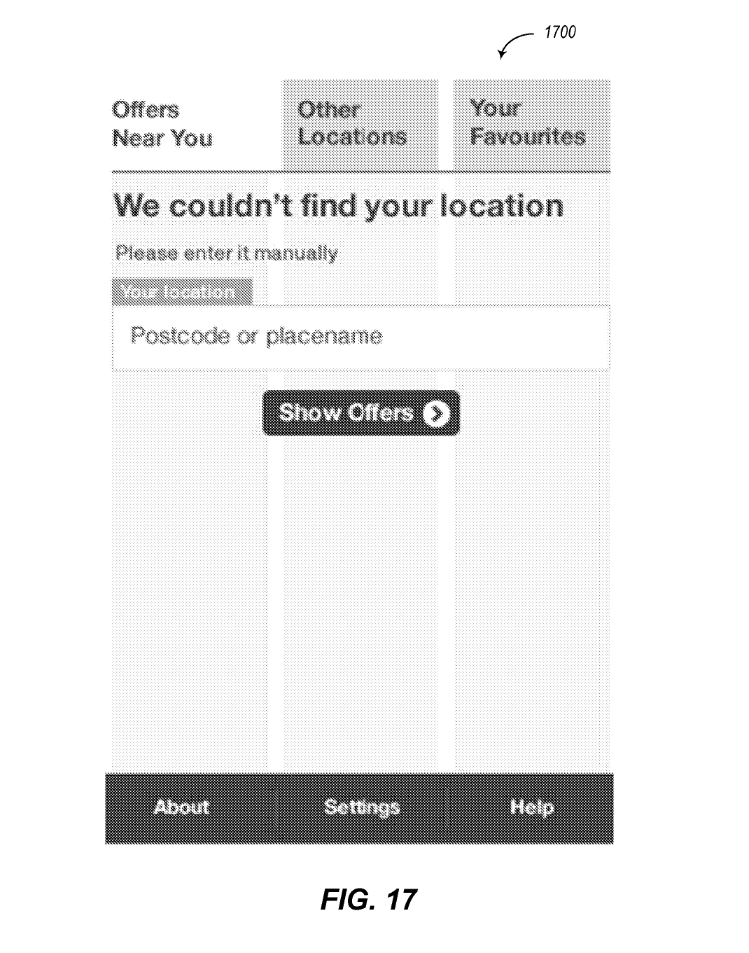

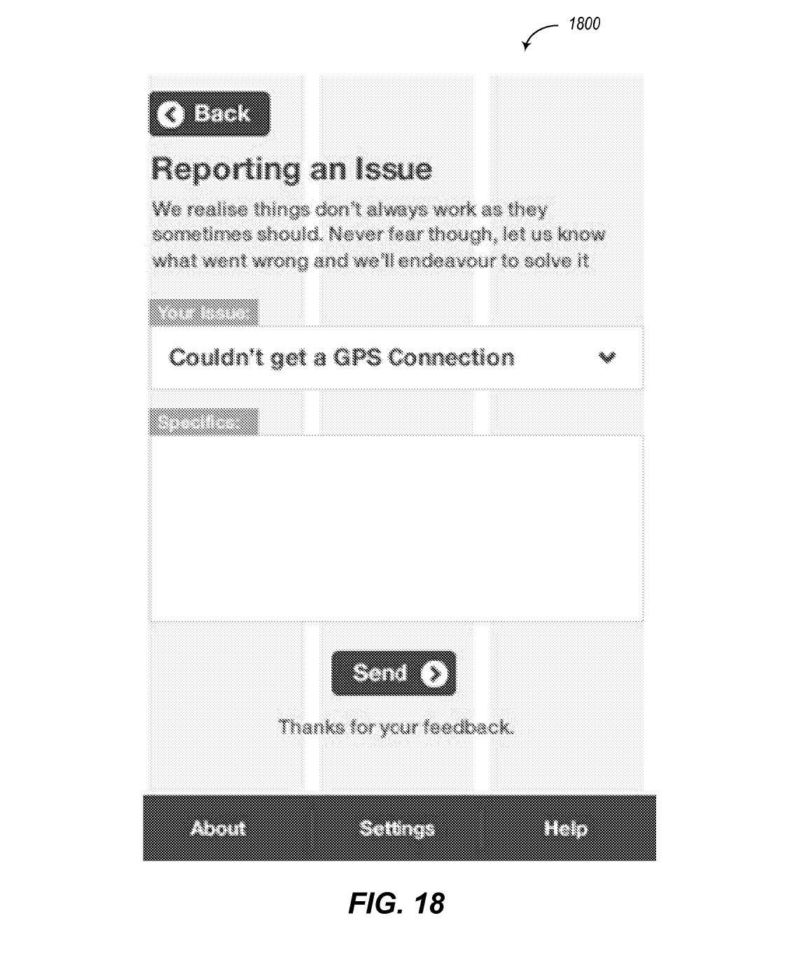

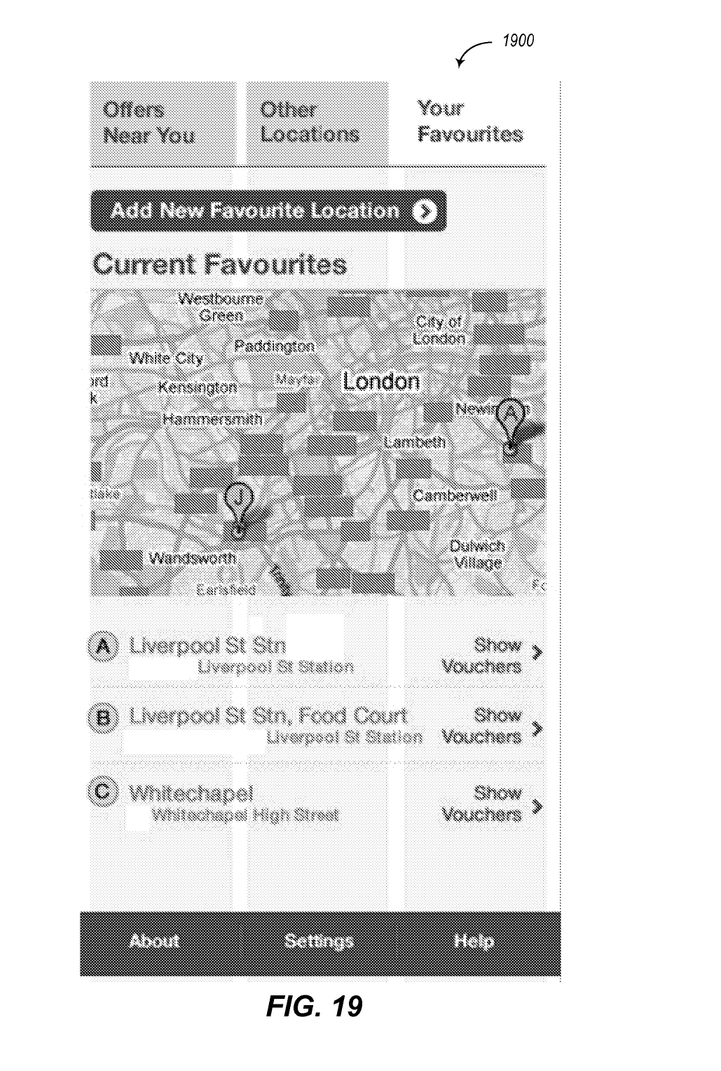

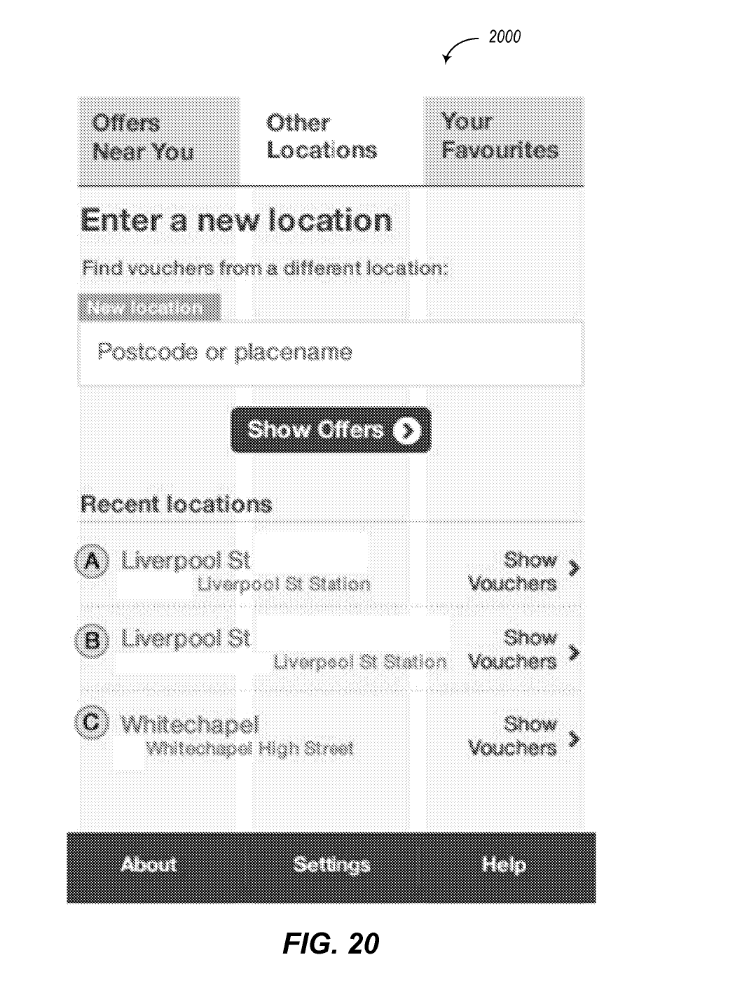

If the device 110 is unable to identify its coordinates using any or all of the foregoing techniques, the device 110 may generate 440 an location prompt for display at the display screen 115 of the device 110. An exemplary status display is shown with respect to FIG. 16. The location prompt may be displayed as a location prompt field 441, which may be, for example, one or more input fields. The step of generating 440 the location prompt may include, for example: (i) identifying previous merchants where the user has entered into valid couponing transactions based on past transactions 442 for the user at the transaction history library 260; (ii) identifying preselected merchants that the user has selected as “favorites” based on the user's profile at the user accounts library 220; (iii) identifying merchants or geo-strings for which the user has previously searched based on the user's profile at the user accounts library 220; or (iv) identifying geo-strings or merchants where the user has previously located itself based on the user's profile at the user accounts library 220. The location prompt field 441 may be populated to include, for example, any of these merchants identified in (i)-(iv) so that the user may select one of such merchants. Alternatively, the location field 441 may allow the user to manually enter a merchant code. The merchant code may be, for example, the Merchant_ID or a temporary code that is issued to a given merchant location that changes on a periodic basis in order to reduce the likelihood of abuse. Responsive to receiving an input or selection 443 of a value or values in the location prompt field 441, the coupon redemption module 123 may determine 450 the coordinates of the client device 110 by cross referencing the input or selected value 443, such as the Merchant_ID, to the coordinates of the merchant using the merchant information library 210. Exemplary location prompt fields 541 is shown with respect to FIG. 17, FIG. 19, and FIG. 20.

In the event that the user does not know of the Merchant_ID, the user may manually enter a “geo-string” into the location prompt field 441. Responsive to receiving an input or selection of a geo-string value 443 in the location prompt field 441, the coupon redemption module 123 may determine 450 the coordinates of the client device 110 by cross referencing the input geo-string value 443 to corresponding coordinates 451 using the geo-string library 240. In the event that the input geo-string value 443 does not correspond to coordinates at the geo-string library of the device database 118, the client device 110 may request 460 of the server 130 to perform a remote lookup of the geo-string value 443 to determine the corresponding coordinates 461. Exemplary location prompt fields 541 for entering a “geo-string” are shown with respect to FIG. 17.

If coordinates are successfully obtained according to any of steps 430, step 450, or step 460, the device 110 may record the resulting coordinates in the user session table 200 for reference by the coupon-delivery module 122 and other modules. Alternatively, the software routines for locating mobile device 110 may run on server 130 and use communications link 101 to work in tandem with device 110 and the other applications resident on mobile device 110. In an alternative embodiment of the system, functions are performed by server 130 using data supplied by the client device 110. The output of such functions performed by server 130 may be then transmitted to device 110 via communications link 101. Such an alternative embodiment may be used where the security concerns outweigh the speed and convenience of such functions being performed on device 110.

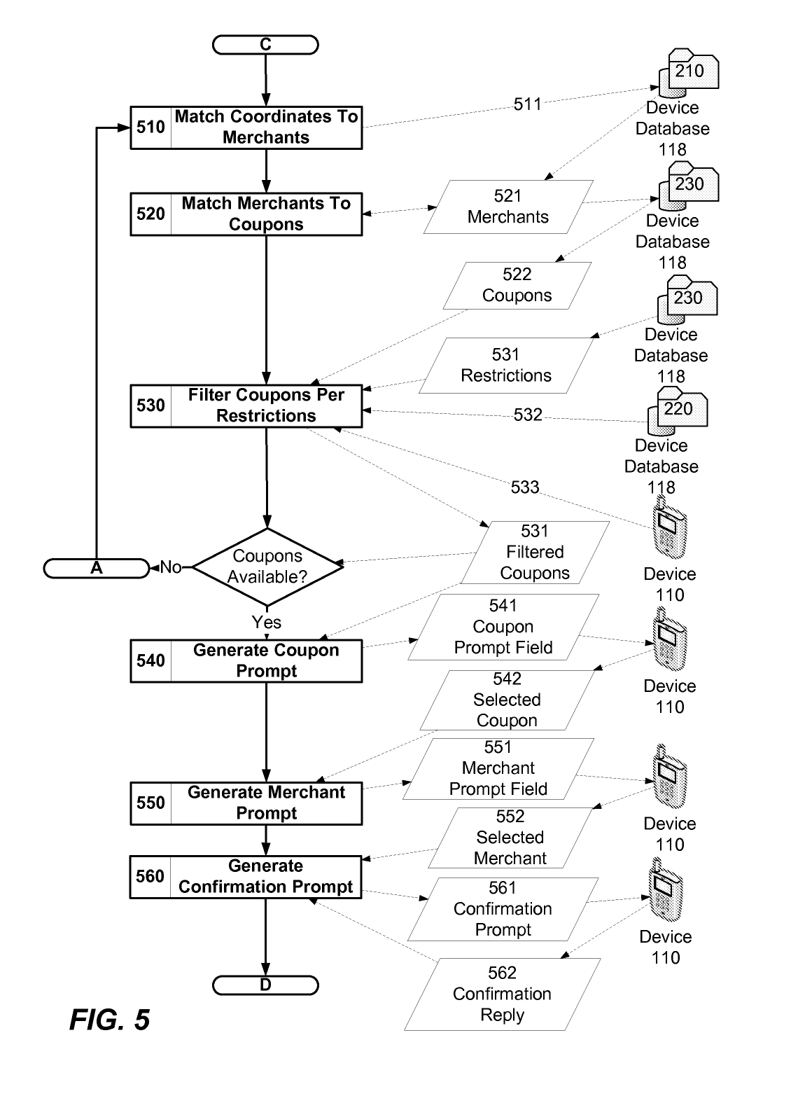

As is shown with reference to FIG. 5, the client device 110 may match 510 the coordinates 511 from the user session table to one or more Merchant_IDs at the merchant information library 210. Referring back to FIG. 4, to the extent that the user's selection 443 includes a Merchant_ID, selected Merchant_ID 443 may be stored at the user session table 200 and the step 510 may be bypassed so that coupons are delivered only with respect to the selected Merchant_ID 443. As may further be shown with reference to FIG. 5, the client device 110 may match 520 one or more Merchant_IDs 521 to one or more Coupon_IDs 522 at the merchants-coupons library 250.

The coupon-delivery module 122 may further include instructions for coupon restriction. As coupons at the electronic coupons library 230 may include certain rules and restrictions, coupons may be restricted from being offered or delivered to a user if the rules and restrictions are not satisfied. Coupon-delivery module 122 may filter 530 the coupons 522 that were matched according to step 520 based on, for example, matching session properties 533, such as the Device_ID, User_ID, time of last synchronization, or time of day, as provided by the user session table 200, to related restrictions 531 as provided by the electronic coupons library 230. Coupon-delivery module 122 may also filter 530 the coupons 522 that were matched according to step 520 based on, for example, matching the user properties 532 from the user account table 220 to related restrictions as provided by the electronic coupons library 230. Coupon-delivery module 122 may also filter 530 the coupons 522 that were matched according to step 520 based on, for example, the number of coupons available as provided by the electronic coupons library 230. The coupons remaining after the filtering 530 step are referred to herein as the “filtered coupons” 531. The coupon-delivery module 122 may check whether the number of filtered coupons 531 meets a predefined number and whether the last synchronization time is within a predefined time period, and the coupon-delivery module may call the update module 121 to resynchronize the data on the device 110 and then return to step 510 to identify merchants and coupons that may not have been present in the data on device 110 prior to the resynchronization. By updating the device 110, additional coupons that are valid may be transmitted by server 130 to client 110.

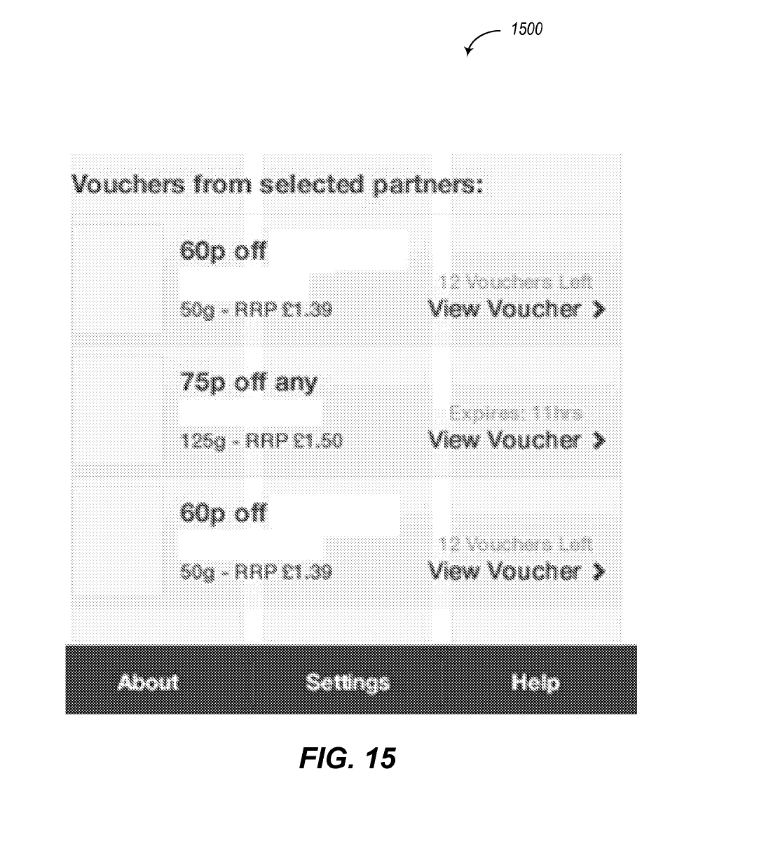

As is shown with reference to FIG. 5, the coupon-delivery module 122 may further include instructions for generating 540 a coupon prompt for display at the display screen 115 of the device 110. The coupon prompt may be displayed as a coupon prompt field 541, which may be, for example, one or more input fields. The coupon prompt field 541 is populated to include each of the filtered coupons 531 so that the user may select one of such coupons. The step of generating 540 the coupon prompt may include, for example, sorting the filtered coupons 531 based on variables such as distance between the merchant location and the client device, which may be determined responsive to the coordinates of the client device 110 and the coordinates of the merchant location by cross referencing the Coupon_ID of each coupon at the electronic coupons library 230 to the coordinates for a merchant location at the merchant information library 210. Sorting the filtered coupons 531 may also be based on variables such as popularity of the coupon, which may be determined responsive to the number of times the coupon has been used, which may be determined by cross referencing the Coupon_ID of each coupon at the electronic coupons library 230. The coupon prompt field 541 may be associated with the Coupon_ID of each of the filtered coupons so that, upon selection and submittal by a user, the coupon-delivery module 122 receives the Coupon_ID of the selected coupon. The coupon prompt field 541 may include for display at the display screen any of the coupon properties, such as those properties in the electronic coupons library 230. An exemplary coupon prompt field 541 is shown with respect to FIG. 15.

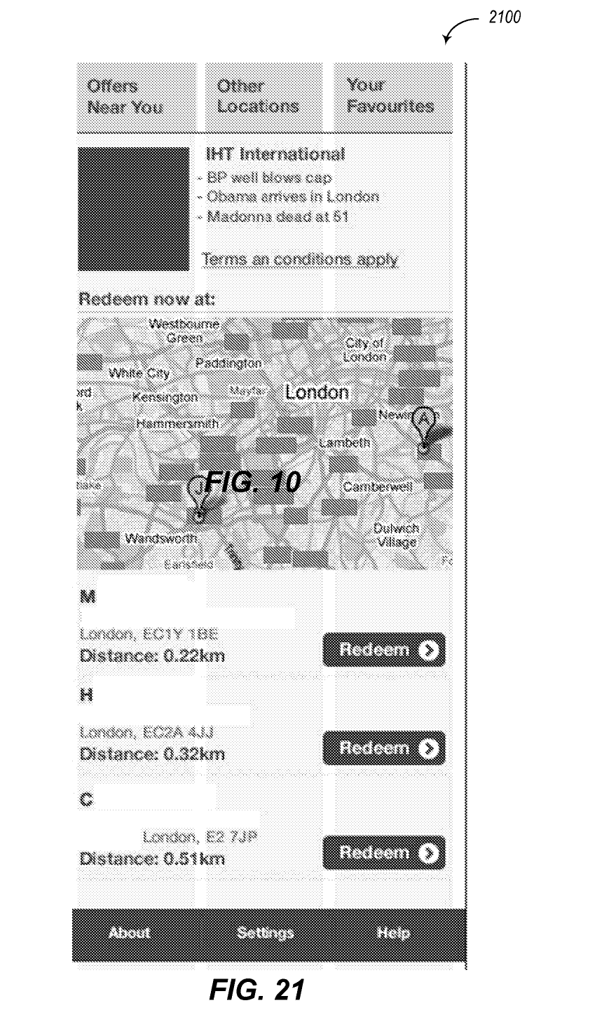

Responsive to receiving a selected coupon 542, such as a Coupon_ID, from the user with respect to the coupon prompt field 541, the coupon-delivery module 122, as is shown with reference to FIG. 5, may further include instructions for generating 550 a merchant location prompt for display at the display screen 115 of the device 110. The merchant location prompt may be displayed as a merchant location prompt field 551, which may be, for example, one or more input fields. The merchant location prompt field 551 may be populated to include the properties of the merchants offering the selected coupon 542 so that the user may select one of such merchants. The properties of the merchants offering the selected coupon may be determined by cross referencing the Coupon_ID to one or more Merchant_IDs at the merchants-coupons library 250 and the merchant properties at the merchant information library 210. The step of generating 550 the merchant location prompt may include, for example, or filtering the merchant locations based on variables such as distance between the merchant location and the client device, which may be determined responsive to the coordinates of the client device 110 and the coordinates of the merchant location by cross referencing the Merchant_ID for each coupon to the coordinates for a merchant location at the merchant information library 210. Some merchant locations may be filtered out if the distance between the merchant location and the client device 110 is greater than a predefined distance, to reduce the likelihood of the user making a mistake or engaging in fraud. The merchant location prompt field 551 may be associated with the Merchant_ID of each of the one or more merchants offering the selected coupon so that, upon selection and submittal by a user, the coupon-delivery module 122 receives the Merchant_ID of the selected merchant. The merchant location prompt field 551 may include for display at the display screen any of the merchant properties, such as those properties in the merchant information library 210. Exemplary merchant location prompt fields 551 are shown with respect to FIG. 21.

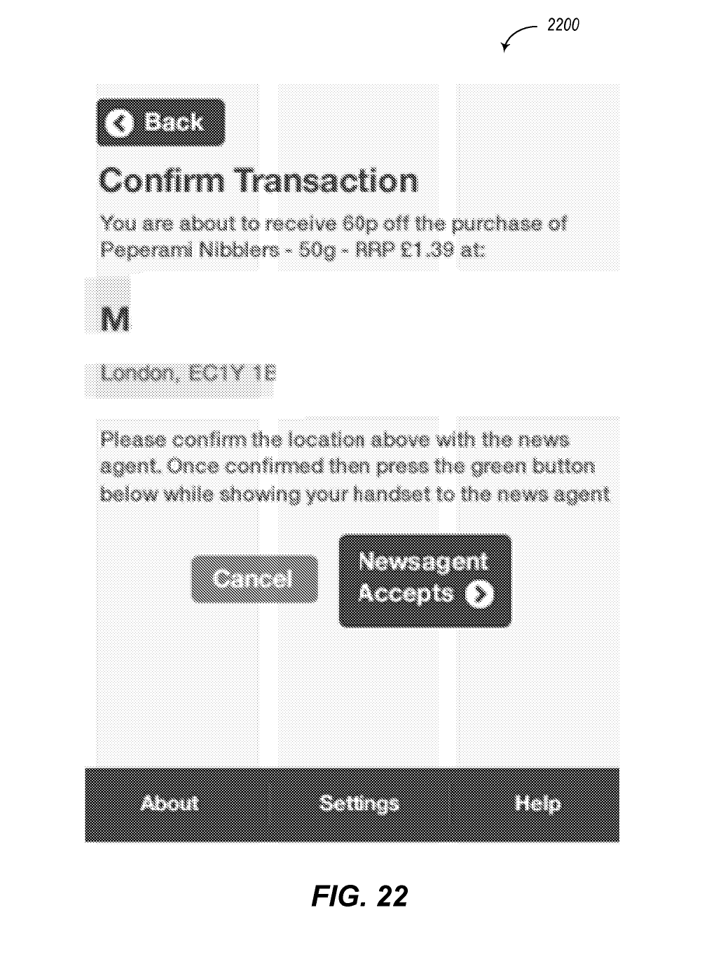

Responsive to receiving a selected merchant location 552, such as a Merchant_ID, from the user with respect to the merchant location prompt field 551, the coupon-delivery module 122, as is shown with reference to FIG. 5, may further include instructions for generating 560 a merchant confirmation prompt for display at the display screen 115 of the device 110. The merchant confirmation prompt may be displayed as a merchant confirmation prompt field 561, which may be, for example, one or more input fields. The merchant confirmation prompt field 561 may be populated to include the properties of the selected merchant 552 and the selected coupon 542 so that the user and the merchant may confirm that they intend to use the selected coupon 542 in a consumer transaction. An exemplary merchant confirmation prompt field 561 is shown with respect to FIG. 22. The properties of the selected merchant 552 and the selected coupon 542 may be determined by cross referencing the Coupon_ID and the Merchant_ID at the electronic coupons library 230 and at the merchant information library 210. The merchant location prompt field 551 may be associated with a default value so that, responsive to receiving a merchant confirmation or reply 562, the coupon-delivery module 122 receives and recognizes the default value and proceeds to call the coupon-redemption module 123. In alternative embodiments, confirmation may be performed by other methods, including, for example, the following: the merchant or the user typing an authenticating code into the screen of mobile device 110, using mobile device 110 to scan a location-identifying barcode or QR code resident at the merchant location, or swiping mobile device 110 near a RFID chip.

### Coupon Redemption Module 123

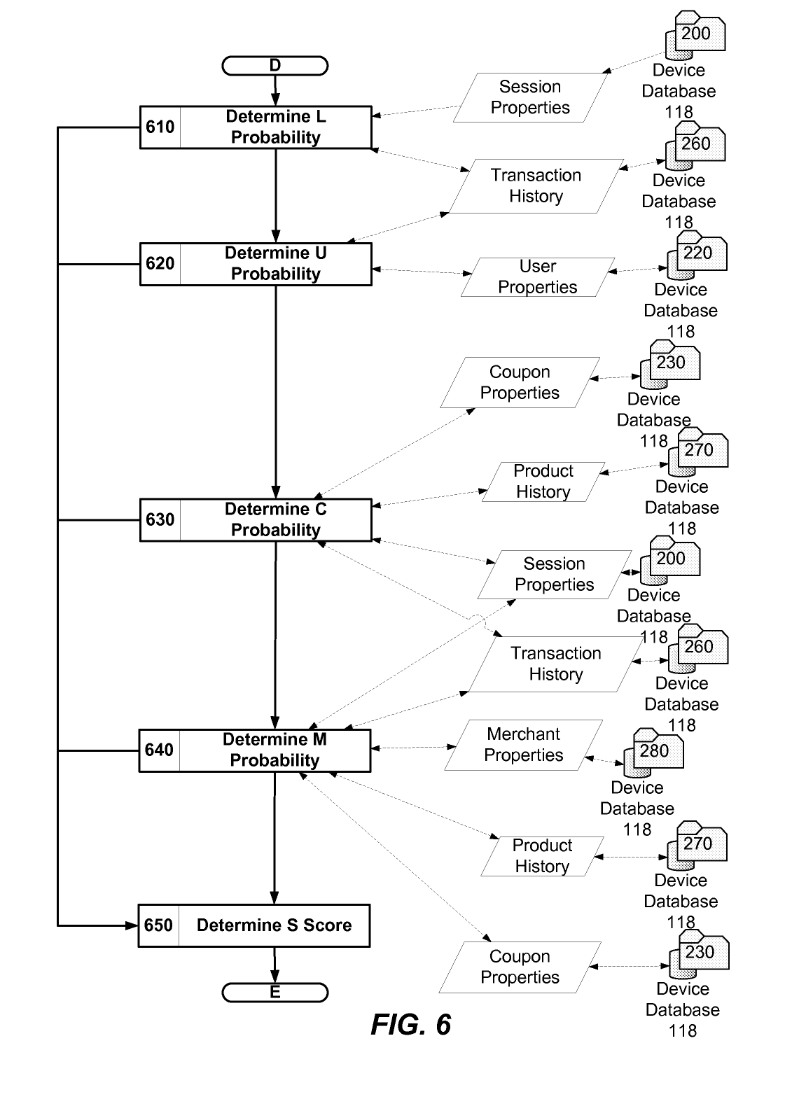

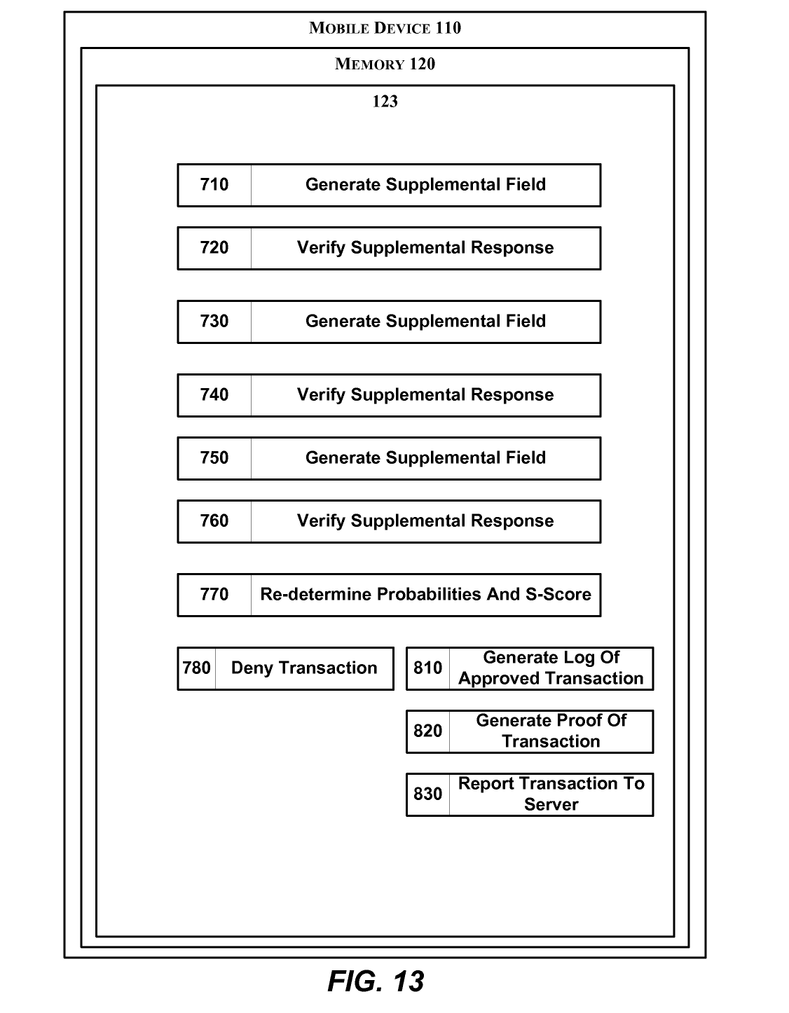

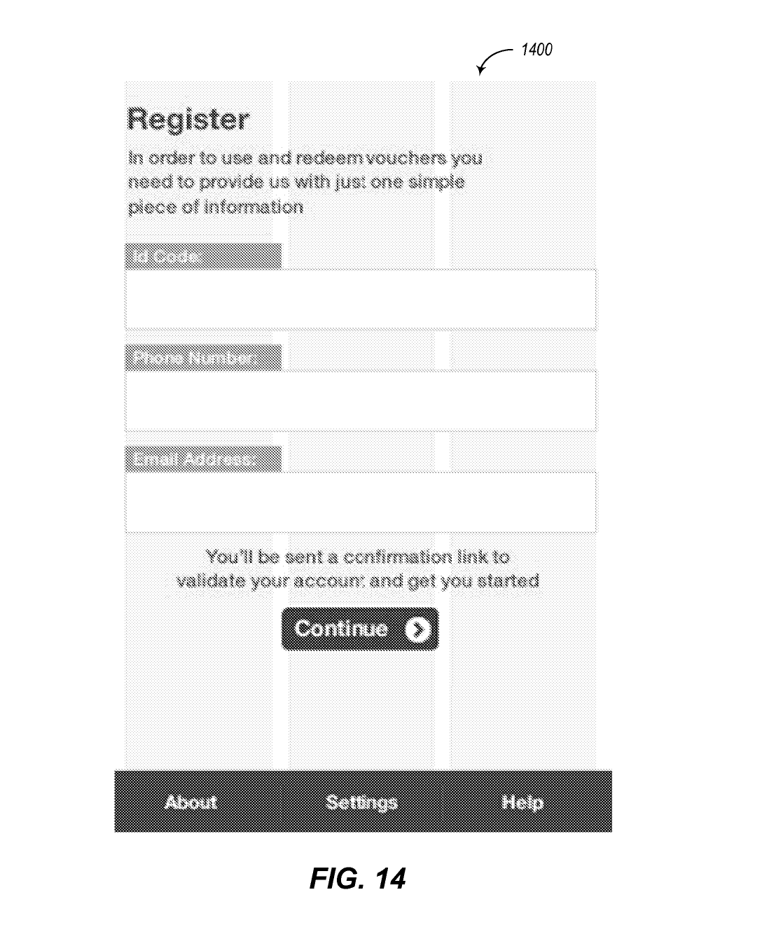

Coupon Redemption Module 123, as is shown with reference to FIG. 13 and FIG. 1, is a computer program product stored in a non-transitory memory and operable on a processor. As is shown with respect to FIG. 1 and FIG. 6, embodiments may include a coupon redemption module 123. The coupon redemption module 123, as is shown with respect to FIG. 6, may include steps for determining 650 a coupon redemption confidence score “S,” for whether to redemption of the coupon for a transaction is valid, such as to accept for redemption the proposed couponing transaction. The score “S” may in some embodiments be a weighted product of probabilities L, U, C, and M according to the formula:

aL+bU+cC+dM=S, where:

L=location probability (also referred to as “L-probability”);

U=user probability (also referred to as “U-probability”);

C=coupon mis-redemption probability (also referred to as “C-probability”);

M=coupon mal-redemption probability (also referred to as “M-probability”);

a=a predefined multiplier for weighting of location probability;

b=a predefined multiplier for weighting of user probability;

c=a predefined multiplier for weighting of coupon mal-redemption probability; and

d=a predefined multiplier for weighting of coupon mal-redemption probability.

In other embodiments, a determined coupon redemption confidence score may be generated in other manners, such as by combining one or more calculated probabilities or other determined likelihoods for one or more factors that include at least one of the L-probability, U-probability, C-probability and M-probability (as discussed in greater detail below), optionally including one or more determined weighting factors.

The coupon redemption module 123, as is shown with respect to FIG. 6, may include steps for determining 610 the location probability, or L-probability, which is a probability that a given merchant location is actually where the proposed transaction is taking place.

The L-probability may be determined responsive to session properties, such as the client device location, the accuracy of the client device location, whether the device is indoors or outdoors, the quality of the method of determining the device location, and the number of satellites to which the receiver has a clear line of site, which may be obtained from the user session table 200.

Further, The L-probability may be determined responsive to user-transaction properties, such as the number or type of merchant locations where the User_ID or the Device_ID of the current transaction has engaged in valid past transactions, which may be obtained from the transaction history table 260.

The L-probability may be determined responsive to statistical tables to correlate such session properties or user-transaction history, individually or in combination, to a value between 0 and 100 depending on, for example, risk tolerance of the issuer, other factors affecting U, C, and M, or transaction history for all users. Where multiple session properties or user-transaction history are used in combination, for example, the statistical correlation would yield a higher probably as a result of corroboration.

The coupon redemption module 123, as is shown with respect to FIG. 6, may include steps for determining 620 the user probability, or U-probability, which is a probability that a given user has been positively identified.

The U-probability may be determined responsive to user-transaction properties, such as a the Merchant_ID, Name, and Type of merchants from the user's list of “favorite” merchant locations as previously input by the user, which may be obtained from the user accounts library 220 with respect to the user's User_ID or Device_ID. For example, by linking a unique Device_ID with a given user on the database, the name and other personal details may never be known for the user, but the user is linked to an individual mobile device in the database on server 130. By using the unique mobile device ID, a given user may be positively identified by the system without use of a password.

Further, The U-probability may be determined responsive to user-transaction properties, such as the number or type of merchant locations where the User_ID or the Device_ID of the current transaction has engaged in valid past transactions, which may be obtained from the transaction history table 260.

The U-probability may be determined responsive to statistical tables to correlate such user-transaction history or user properties history, individually or in combination, to a value between 0 and 100 depending on, for example, risk tolerance of the issuer, other factors affecting L, C, and M, or transaction history for all users. Where multiple session properties are used in combination, for example, the statistical correlation would yield a higher probably as a result of corroboration.

The coupon redemption module 123, as is shown with respect to FIG. 6, may include steps for determining 630 the coupon mis-redemption probability, or C-probability, which is a probability that a proposed transaction is free of coupon mis-redemption.

The C-probability may be determined responsive to coupon properties, such as the size of the discount or the size of the discount relative to the purchase price of the item purchased, any of which may be obtained from the electronic coupon library 230 with respect to the Coupon_ID for the selected coupon.

Further, the C-probability may be determined responsive to product history, such as the normal time of day for purchase for the SKU (e.g., orange juice is normally purchased from a news agent in the morning), the normal frequency of purchase of the SKU at a given merchant location (i.e., the higher the proposed frequency, the lower the probability that the intended product is being purchased), the number of SKUs already purchased within a given period of time (e.g., whether the particular SKU exceeds the likely stock for a given merchant location), and the likelihood of the merchant location stocking the SKU (e.g., a news agent that is not known to have a freezer is less likely to sell an ice cream SKU), any of which may be obtained from the transaction history library 260 with respect to the Product_ID of the selected coupon.

Further, the C-probability may be determined responsive to transaction history, such as the history of mis-redemption at a given merchant location (indicating that a given merchant may either be sloppy in accepting coupons or may sometimes conspire with customers to perpetrate coupon mis-redemption), the history of coupon mis-redemption or attempted coupon mis-redemption from a given user or mobile device, or the history of mal-redemption at a given merchant location, any of which may be obtained from the electronic coupon library 230 with respect to the Coupon_ID for the selected coupon.

Further, the C-probability may be determined responsive to session properties, such as whether communications link 101 is active or not, which may be ascertained from the user session table 200, for example. The foregoing has the advantage of tracking coupon redemption in real time so that proposed couponing transactions may more robustly tracked and compared to normal and/or expected levels of activity for a given coupon.

The C-probability may be determined responsive to statistical tables to correlate such coupon properties, product history, session properties, and transaction history, individually or in combination, to a value between 0 and 100 depending on, for example, risk tolerance of the issuer, other factors affecting L, U, and M, or transaction history for all users. Where multiple session properties are used in combination, for example, the statistical correlation would yield a higher probably as a result of corroboration.

The coupon redemption module 123, as is shown with respect to FIG. 6, may include steps for determining 640 the coupon-mal redemption probability, or M-probability, which is a probability that a proposed transaction is free of mal-redemption.

The M-probability may be determined responsive to merchant-transaction history, such as the number of declined couponing transactions at a given merchant location, history of mal-redemption at a given merchant location, history of coupon mis-redemption at a given merchant location (indicating that a given merchant may either be sloppy in accepting coupons or may sometimes conspire with customers to perpetrate coupon mis-redemption), normal frequency of couponing transactions at a given merchant, normal frequency of couponing transactions for similar SKUs at a given merchant location, the likelihood of a particular merchant location stocking a given type of SKU, any of which may be obtained from the transaction history library 260 with respect to the Merchant_ID for the selected merchant. For example, more emphasis is placed upon the variables in the control of a given merchant.

The M-probability may be determined responsive to session properties, such as whether communications link 101 is active or not, which may be ascertained from the user session table 200, for example. The M-probability may be further determined responsive to coupon properties, such as the size of the discount or the size of the discount relative to the purchase price of the item purchased, any of which may be obtained from the electronic coupon library 230 with respect to the Coupon_ID for the selected coupon.

Further, the M-probability may be determined responsive to product history, such as the normal time of day for purchase for the SKU (e.g., orange juice is normally purchased from a news agent in the morning), the normal frequency of purchase of the SKU at a given merchant location (i.e., the higher the proposed frequency, the lower the probability that the intended product is being purchased), the number of SKUs already purchased within a given period of time (e.g., whether the particular SKU exceeds the likely stock for a given merchant location), and the likelihood of the merchant location stocking the SKU (e.g., a news agent that is not known to have a freezer is less likely to sell an ice cream SKU), any of which may be obtained from the transaction history library 260 with respect to the Product_ID of the selected coupon.

Further, the M-probability may be determined responsive to transaction history, such as the history of mis-redemption at a given merchant location (indicating that a given merchant may either be sloppy in accepting coupons or may sometimes conspire with customers to perpetrate coupon mis-redemption), the history of coupon mis-redemption or attempted coupon mis-redemption from a given user or mobile device, or the history of mal-redemption at a given merchant location, any of which may be obtained from the electronic coupon library 230 with respect to the Coupon_ID for the selected coupon.

The M-probability may be determined responsive to statistical tables to correlate such coupon properties, product history, session properties, and transaction history, individually or in combination, to a value between 0 and 100 depending on, for example, risk tolerance of the issuer, other factors affecting L, U, and C, or transaction history for all users. Where multiple session properties are used in combination, for example, the statistical correlation would yield a higher probably as a result of corroboration.

The method for determining the probability of mal-redemption, the M-Probability, is advantageous over the Related Art in that the identity of the user is generally known because the client application is locked to a specific mobile device 110. Because the proposed couponing transaction is linked with a high degree of certainty to a particular unique device ID, the risk of mal-redemption is greatly reduced. Linking transactions to individual mobile devices inhibits opportunities for individual merchants to attempt the bulk mal-redemption of coupons without being detected. In other words, a high U-Probability generally correlates to a low M-probability.

In the manner described in the above paragraphs, the L-Probability, U-Probability, C-Probability, and M-Probability, are not necessarily independently generated. Each probability may be enhanced (or alternatively reduced) through the probabilities generated by the other three probabilities. For example, the L-probability may be reduced if the C-probability and the M-probability are below certain thresholds. In such an event, the system may seek more validating information before authorizing a transaction. Such an outcome may occur because one of the four probabilities or the S-Score does not meet the predefined threshold for a given coupon. In such circumstance, the coupon redemption module 123 may generate a list of additional information desired from the user. In an alternative embodiment, such request(s) for further information may be transmitted by the server 130 to client device 110.

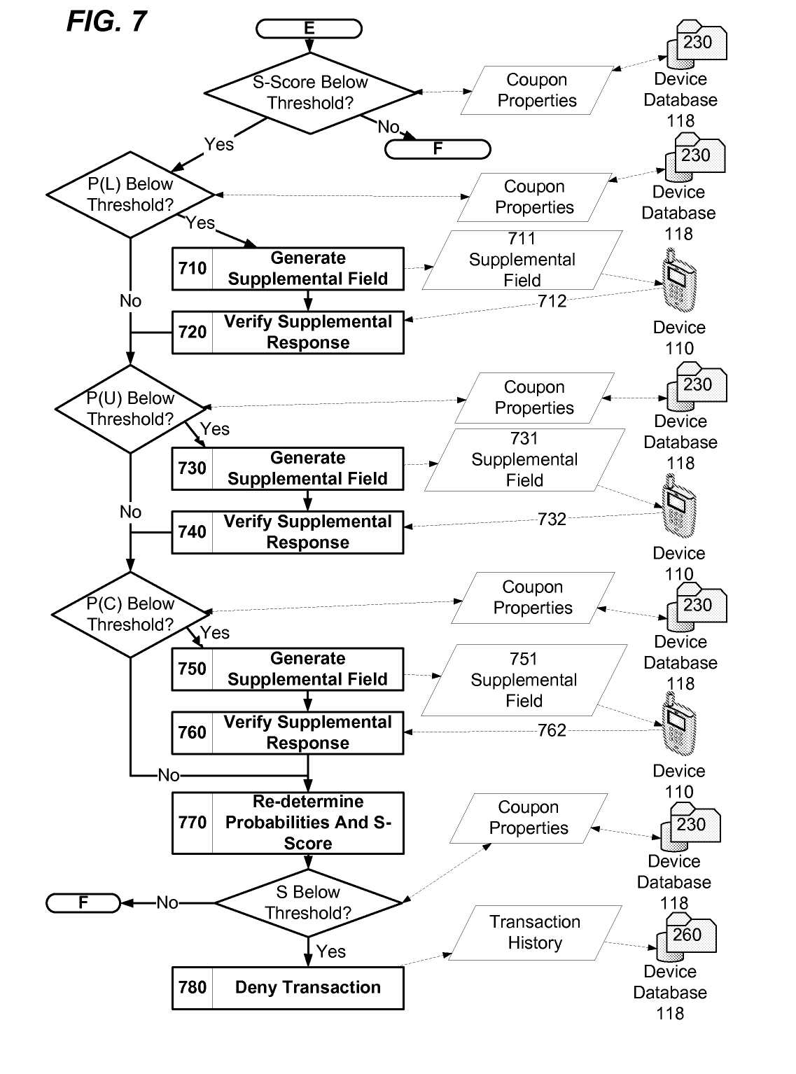

The coupon redemption module 123, as is shown with respect to FIG. 7, may include steps for determining whether the S-Score, or any of the L-Probability, U-Probability, C-Probability, or M-Probability are below a predefined threshold, which may be, for example, defined in the coupon properties for the selected coupon in the electronic coupons library 230.

In the event that the L-Probability, U-Probability, or C-Probability is below the predefined threshold, the coupon redemption module 123 may generate 710, 730, 750 a supplemental prompt for display at the display screen 115 of the device 110. The supplemental prompt may be displayed as a supplemental prompt field 711, 731, 751, which may be, for example, one or more input fields. The location field 711, 731, 751, may allow the user to manually enter a text string or attach multimedia content with respect to a property that the coupon redemption module 123 is asking the user to verify.

For example, where the L-probability is below the predefined threshold, the coupon redemption module 123 may generate 710 a supplemental prompt field 711 querying the user for a unique code known only to the local merchant, a bar code or QR code to identify the location, a scan of a RFID chip local to the merchant location, or a photograph of the merchant location. Responsive to receiving an input or selection 712 of a value or values in the supplemental prompt field 711, the coupon redemption module 123 may verify 720 the input or selection 712 by cross referencing the input or selection 712 to properties in the merchant information library 210.

Also, for example, where the U-probability is below the predefined threshold, the coupon redemption module 123 may generate 730 a supplemental prompt field 731 querying the user for a unique password or personal identification number known only to the user of the system, the postal code of the user's home or business address, the last four digits of the user's social security number, the answer to a unique security question provided earlier by the user, or analogous information that may be used to corroborate the identity of the user. Responsive to receiving an input or selection 732 of a value or values in the supplemental prompt field 731, the coupon redemption module 123 may verify 740 the input or selection 732 by cross referencing the input or selection 732 to properties in the user account library 220.

Also, for example, where the C-probability is below the predefined threshold, the coupon redemption module 123 may generate 750 a supplemental prompt field 751 querying the user for a portion of the UPC code printed on the packaging of a given SKU, a scan of such UPC code, one of a series of question for the user to answer about the SKU (e.g., “Please enter the last four digits of the phone number located at the bottom of the box of cereal you are purchasing”), and analogous identifying methods. Responsive to receiving an input or selection 752 of a value or values in the supplemental prompt field 751, the coupon redemption module 123 may verify 760 the input or selection 752 by cross referencing the input or selection 752 to properties in the product library 270.

It should be noted that an additional subroutine for corroborating the M-probability is not listed as it is generally not dependent upon actions by a given user, but instead is more dependent upon variables more specific to a given merchant location. The exception is where mal-redemption is being attempted by a given user or mobile device. In such case, the User_ID or Device_ID may be blocked, for example, using the coupon restrictions.

The location authorization subroutine described herein is re-run and used to update the probability that a given mobile device is actually at a given location. The new probability is matched against the threshold that is defined or otherwise determined for use with a given coupon. If such a probability if higher than the threshold, then the location probability threshold is met and such information is logged by the server 130. For the sake of clarity, such authorization routine may be run on either client device 110 or server 130

As is shown with respect to FIG. 6 and FIG. 7, after supplemental information has been verified according to steps 720, 740, or 760, the coupon redemption module 123 may re-determine 770 any of the L-Probability, U-Probability, C-Probability, M-Probability, or the S-Score in the same manner as described with respect to steps 610, 620, 630, 640, and 650. In addition, any of the L-Probability, U-Probability, or C-Probability may be determined responsive to statistical tables that also correlate the presence of the supplemental information, in addition to the coupon properties, product history, session properties, and transaction history, individually or in combination, to a value between 0 and 100 depending on, for example, risk tolerance of the issuer, other factors affecting L, U, and C, or transaction history for all users. Once a given transaction has met each of the four probability thresholds and the S-Score threshold, then the transaction will be authorized.

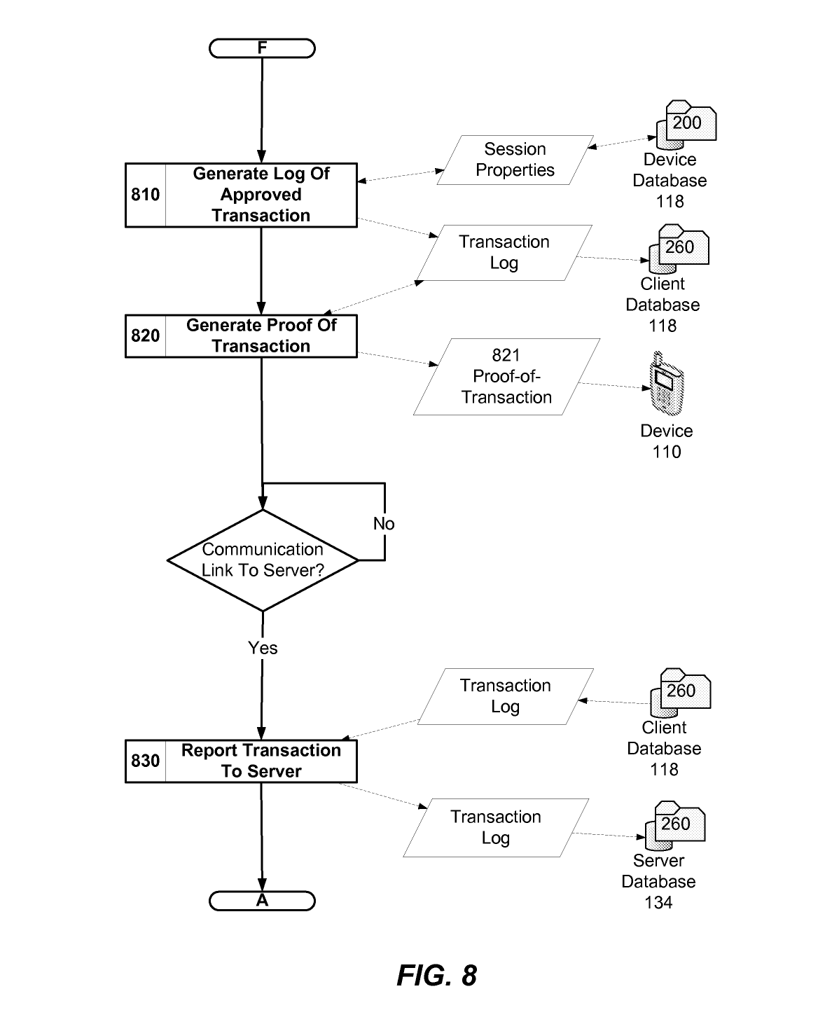

As is shown with respect to FIG. 8, the coupon redemption module 123 may generate 810 a log of the approved transaction in the user session table 200 to flag that the transaction was successful. For example, the coupon redemption module 123 may generate a unique transaction number (Transaction_ID). The coupon redemption module 123 may also write the Transaction_ID, along with all relevant transaction data such as the Issuer_ID, Product_ID, Merchant_Value, User_ID, Device_ID, and Merchant_ID to the transaction history library 260 of the client database 118.

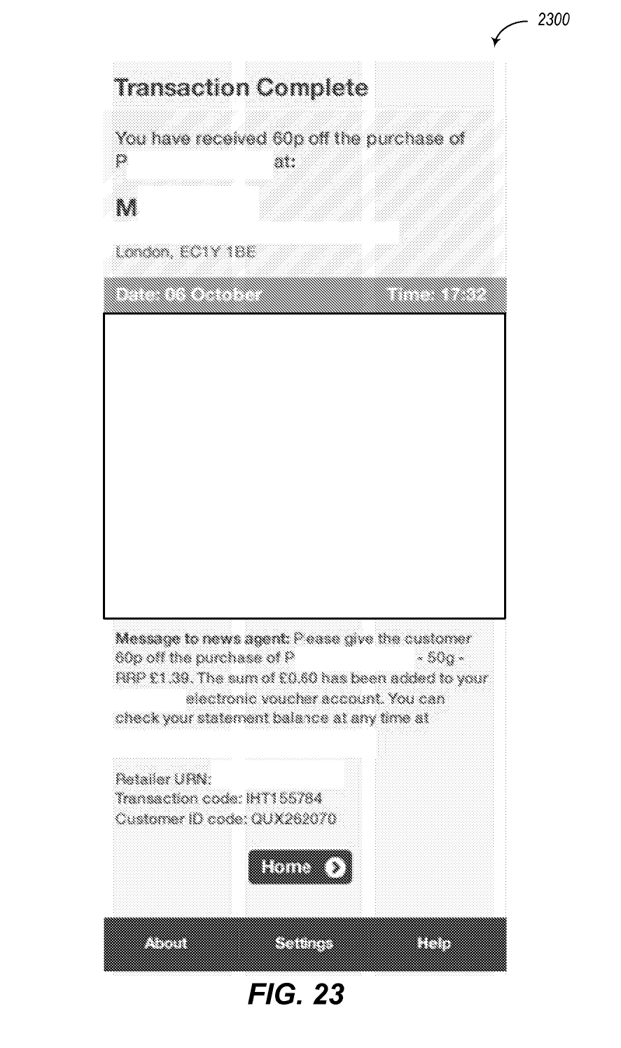

If the transaction is successful, the coupon redemption module 123 may also generate 820 proof of the transaction 821 for display at the display screen 115 of the device 110, which may be shown to the user and/or to the merchant to prove the success of the transaction. An exemplary proof of transaction 821 is shown with respect to a confirmation page illustrated in FIG. 23. It may be beneficial to create such a confirmation page that is not easy to replicate by users and gives assurance to the local merchant that their account has been credited with the transaction. The confirmation page may contain, for example, the Product_ID of the item purchased, the discount that the user is to receive, a time stamp, the Transaction_ID number, the User_ID, and the Merchant_ID. In certain embodiments, an animated .gif may also be included in the confirmation page to make it more difficult to fraudulently reproduce a valid confirmation page for a transaction. In addition, an interim validation screen may be displayed on screen 115 for a limited period of time before the confirmation screen is displayed, to communicate that a couponing transaction has been validated by the coupon redemption system. The interim validation screen may, for example, contain written messages communicating that the transaction is valid and including some of the basic transaction information, such as the amount of the transaction, the date and time (e.g., with the seconds advancing in real time), etc. In some embodiments, the interim validation screen may be displayed while the confirmation page is being downloaded by mobile device 110, and may be useful to merchants and/or users. In certain embodiments, the client application may also contain certain additional safeguards to reduce the ability of users to fraudulently mimic a validated couponing transaction. While such fraud would not hurt the issuers of the system, it could nevertheless damage the credibility of the coupon validating system with merchants. The following validation schemes, for example, may be may be used to inhibit such fraud and serve as an assurance that a genuine transaction has occurred: a unique series of colors, a defined sound, an image, an animated gif, etc. Such schemes have the further advantage of reinforcing to both the user and the merchant that the couponing transaction has been authorized.

The coupon redemption module 123 may also continuously monitor the communication link 101 to the server 130, and write 830 a Transaction_ID, along with all relevant transaction data such as the Issuer_ID, Product_ID, Merchant_Value, User_ID, Device_ID, and Merchant_ID to the transaction history library 260 of the server database 118. If communications link 101 is not active, then the instruction to transmit such transaction information to the server 130 may be cached until such time as the communications link 101 is re-established. Once such communications link is re-established, the transaction information is transmitted to server 130 as described.

### Merchant Redemption Module 142

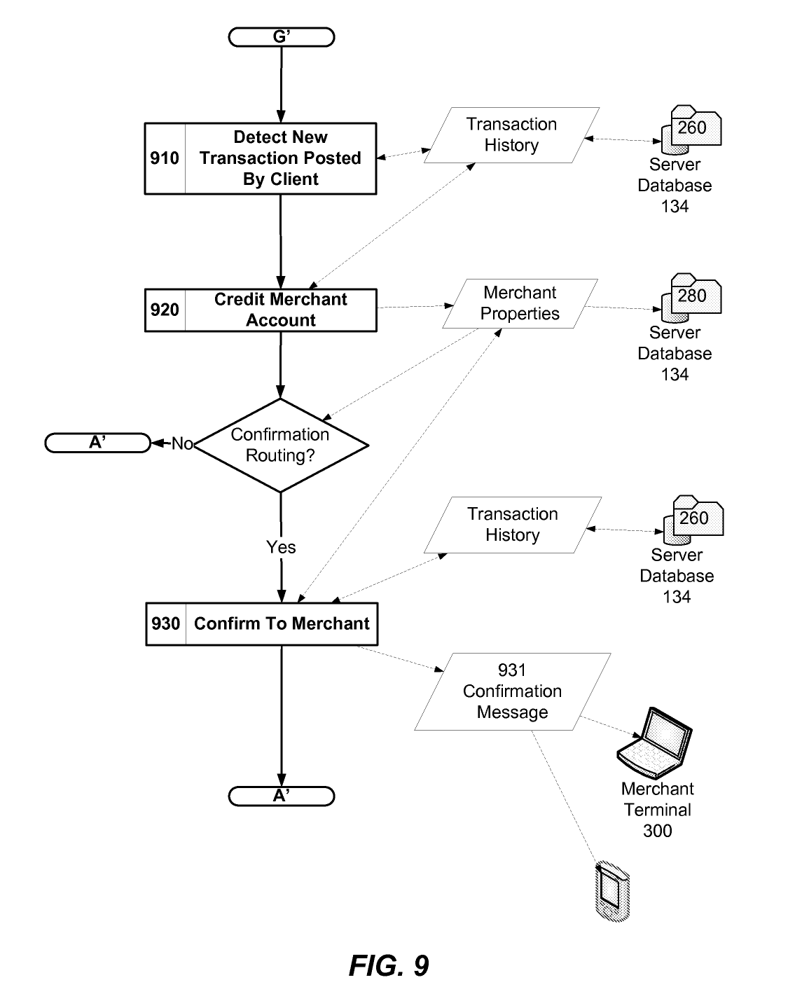

Merchant Redemption Module 142, as is shown with reference to FIG. 1, is a computer program product stored in a non-transitory memory and operable on a processor. As is shown with respect to FIG. 1 and FIG. 9, embodiments may include a merchant redemption module 142. The merchant redemption module 142, as is shown with respect to FIG. 9, may include instructions for detecting 910 a new transaction posted by a client device. The step of detecting 910 the new transaction posted by the client device may further include storing the new transaction in the transaction history library 260 of the server database 134. The merchant redemption module 142 may also include instructions for crediting 920 a merchant account responsive to the new transaction posted by the client device and stored at the transaction history library 260 by cross referencing the Merchant_ID from the new transaction record to a merchant's payment account or credit account at the merchant account library 280. The merchant redemption module 142 can also include instructions for electronically confirming 930 to a merchant the details of the new transaction, provided that the merchant account contains information for routing electronic confirmation. Merchant account library 280 may contain, for example, a mobile telephone number for sending confirmation via SMS, an email address for sending confirmation via email, or a reference to an API or other standards and protocols of a merchant POS terminal 150. In certain embodiments, further confirmation of an individual transaction may be transmitted by server 130 to the local merchant via SMS message, a confirmation email, a message sent via an API on server 130 that links with a given merchant's electronic point of sale transaction system. In certain embodiments of the method, web server 130 also provides a computer program, e.g., web-based, that the local merchant may access in real time and view a history of authenticated couponing transactions.

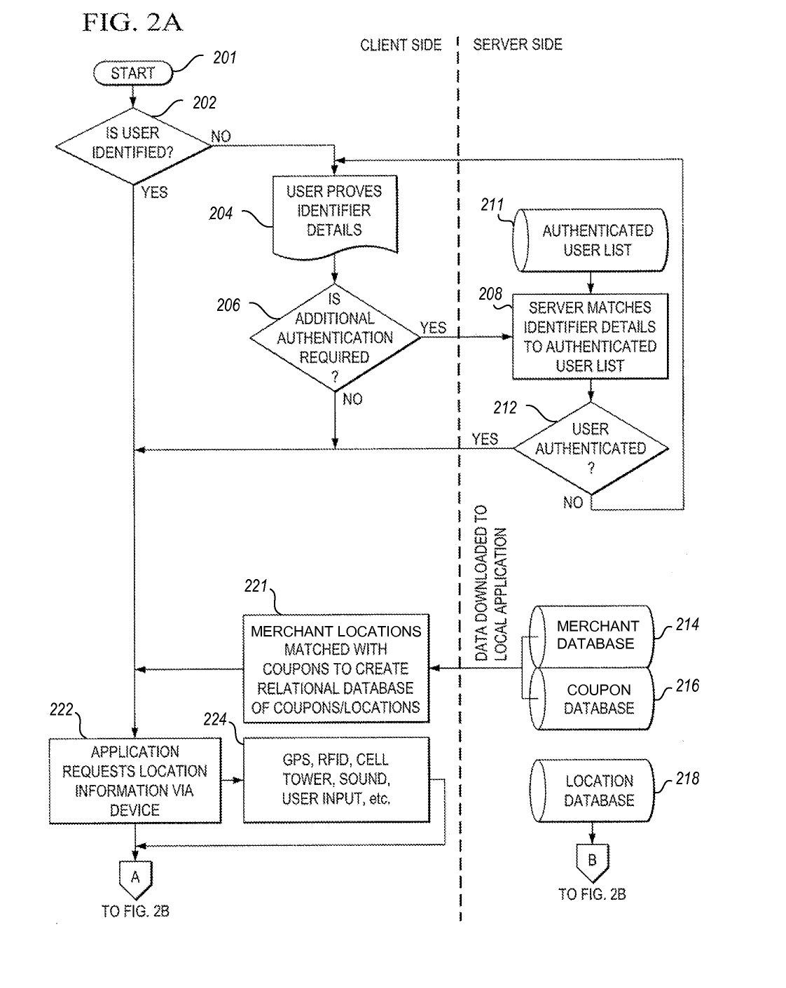

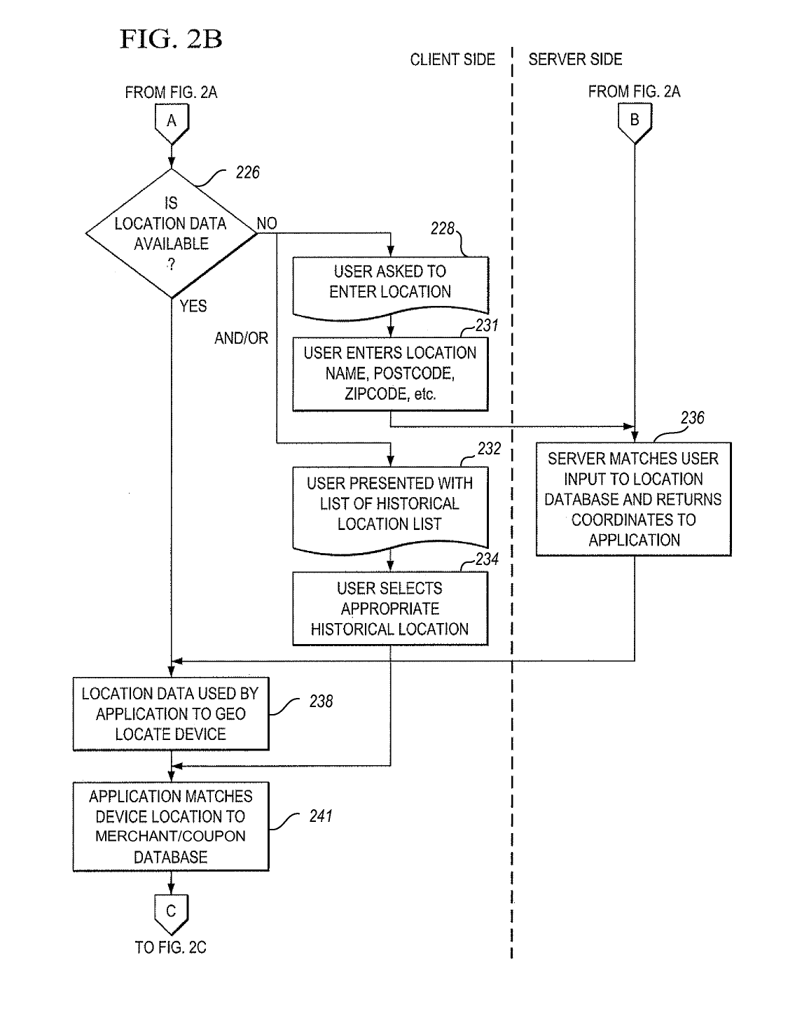

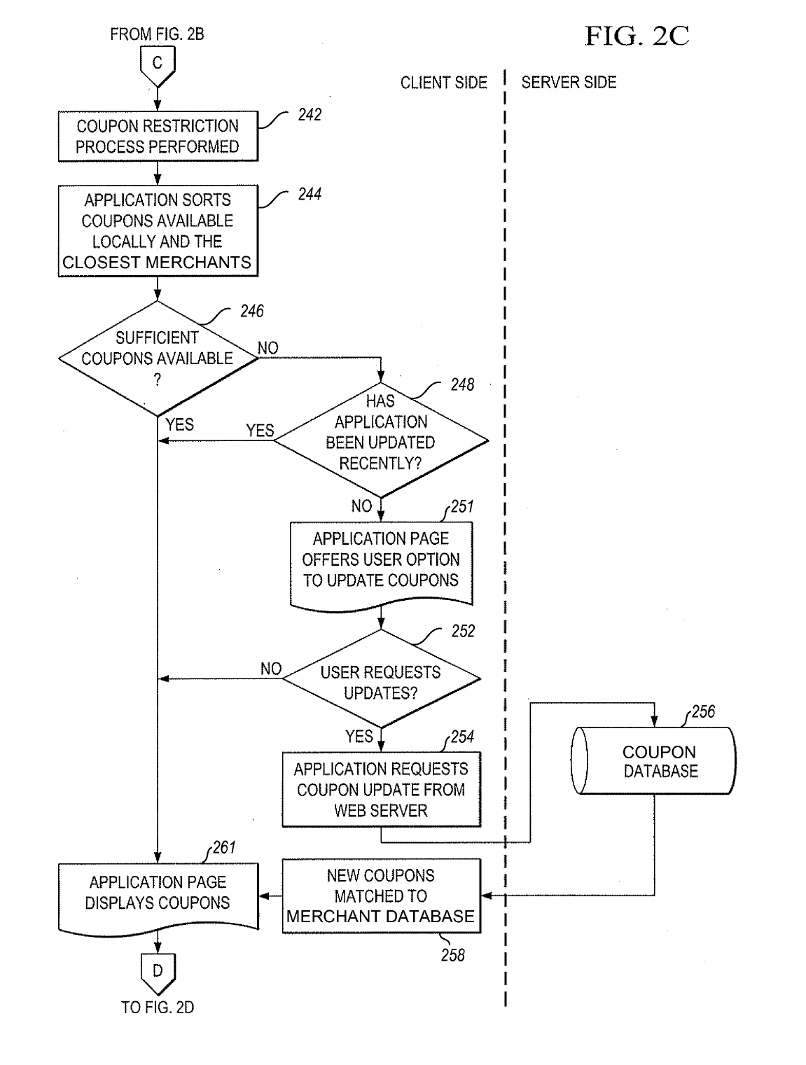

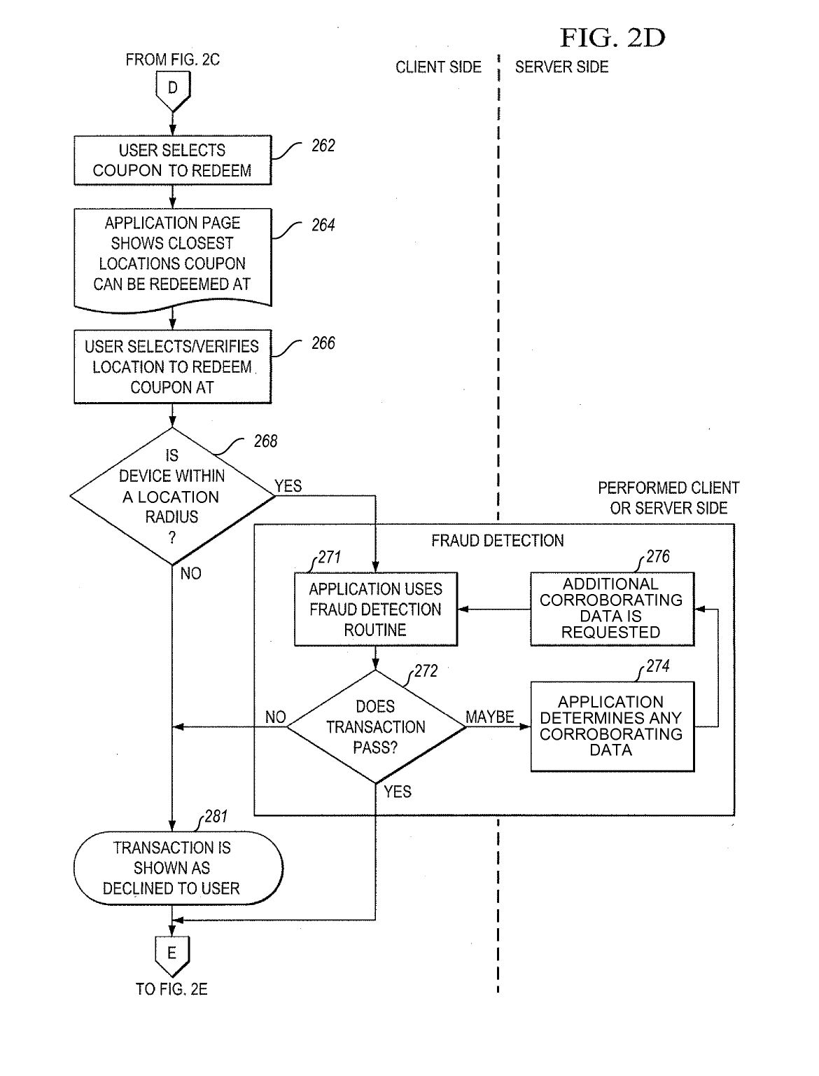

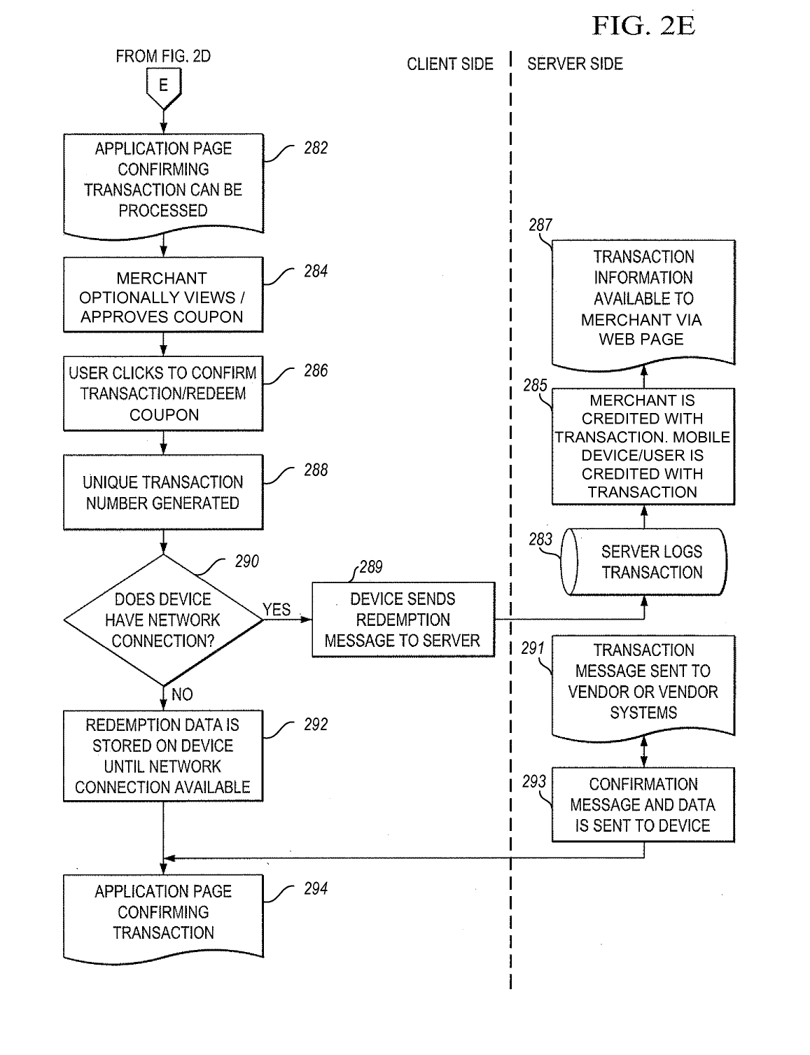

Embodiments of methods are shown with respect to FIGS. 2A-2E.

FIGS. 2A-2E are a flow diagram of an example embodiment of a coupon redemption validity determination routine 201. The routine may be provided by, for example, a coupon redemption system to automatically determine whether redemption of a particular coupon for a particular transaction or otherwise in a particular situation is determined to be valid, such as based on execution of an embodiment of one or more of the modules 121, 122 and 123 of FIG. 1 and/or of one or more of the modules 141, 142 and 143 of FIG. 1. In the illustrated embodiment, particular operations are illustrated as being performed by a mobile device in use by a user, referred to generally as “client side” operations, and other operations are illustrated as being performed by a remote coupon server system, referred to generally as “server side” operations, but in other embodiments particular operations may be performed by other devices or in other manners (e.g., all by a configured mobile device 110, such as a mobile device executing software provided by the coupon redemption system or by an operator of the coupon redemption system, and/or by one or more configured computing systems that provide the coupon server 130). In addition, any references to vouchers correspond generally to coupons as discussed herein, and any references to retailers correspond generally to merchants as discussed herein.

The routine 201 begins at step 202 where a determination is made whether to determine identification of the user of the mobile device, and if so whether such identification has already been performed. If such identification has not already been performed, the routine continues to block 204 to request the user to provide identification details (e.g., a log-in name and/or a password, etc.)—in other embodiments, user identification may instead by provided by a cookie that was previously stored on the mobile device by a remote coupon server system and that is returned to the coupon server system upon request. For example, the coupon server system may request or otherwise obtain a UUID (universal unique identifier) of one or more types from the mobile device, and associate that UUID with the user of the mobile device for a current transaction and optionally for future transactions. In addition, or alternatively, the coupon server system may request the user of the mobile device to call a designated number associated with the coupon redemption system and/or to send an electronic message (e.g., a text message, such as an SMS message or MMS message) to a designated address associated with the coupon redemption system, to enable a phone number or other unique electronic address of the mobile device to be obtained. The obtained phone number or other unique electronic address of the mobile device and/or the obtained UUID may then be stored in a cookie on the mobile device, and later supplied to the coupon server to enable later identification of the mobile device and/or user, such as for later transactions. After block 204, the routine continues to block 206 to determine whether to perform additional identification, and if so continues to block 208, where obtained identifying details regarding the user and/or the mobile device are matched to information from a stored authenticated user list 211. After block 208, the routine determines in block 212 whether the user is authenticated, and if not returns to block 204.

In addition, at one or more prior times, the routine in block 221 receives information from a merchant database 214 and/or a coupon database 216, and proceeds to match coupons with corresponding merchants for later use in presentation to a user of the mobile device.

If it is instead determined in block 202 that the user has been previously identified or to not perform such identification, or in block 206 not to perform additional authentication, or in block 212 that the user has been authenticated, the routine continues to block 222 to determine location information for the user and/or the mobile device. In particular, in block 222 in the illustrated embodiment, one or more modules of a software application executing on the mobile device determine whether to obtain location information via the mobile device if location information is not already available. If location information is not already available and it is determined to obtain location information, the routine continues to block 224 to attempt to determine current location information using one or more techniques that include one or more of a variety of types of wireless transmission of electronic signals and/or user input of corresponding information. After block 224, or if it was instead determined in block 222 that the current location of the mobile device is already known or not to currently obtain location information, the routine continues to block 226 to determine whether to obtain additional location data, such as based on available location information not being sufficient.

If the available location information is not sufficient, the routine continues to one or both of blocks 228 and 232. In block 228, the routine queries the user to input location information, and in block 232, the routine queries the user to select from information about historical locations of the user and/or the device. In particular, if the routine continues to block 228, the user is asked to enter his or her location, and at block 231 the routine receives location information of one or more types. The routine then continues to block 236 where the coupon server matches location information from location database 218 with the information supplied in block 231 in order to determine location coordinates, which are then returned to the mobile device. After block 236, the routine continues to block 238, where the mobile device uses the location coordinate information supplied by the coupon server to perform a geo-location determination for the mobile device. If the routine continues to block 232, information is retrieved about a historical location list for the user and the information is presented to the user, and in block 234 the routine receives information from the user in which the user selects an appropriate historical location corresponding to a current location of the user.

After blocks 234 or 238, the routine continues to block 241 to match a current location of the device/user to one or more coupons in the coupon-merchant database previously discussed with respect to block 221. After block 241, the routine continues to block 242 to determine whether the match coupons include any restrictions or corresponding locations render them currently inappropriate for the user and mobile device, by filtering such inappropriate coupons. In block 244, the routine then optionally sorts the remaining available coupons in one or more manners, such as based on proximity to the device/user of one or more nearby merchants at which the available coupons may be used. The routine then continues to block 246 to determine whether sufficient coupons are available, such as if a minimum number of one or more coupons is previously defined. If not, the routine continues to block 248 to determine whether any updates have recently occurred for the mobile device, and if not continues to block 251 to offer the user the option to update coupons currently stored on the mobile device. In block 252, if the user requests updates to occur, the routine continues to block 254 to request a coupon update from the web-based coupon server, and in block 258 receives new coupons if available from a coupon database 256 and proceeds to match the new coupons to the coupon-merchant database previously discussed.

After block 258, or if it was instead determined in block 246 that sufficient coupons were available, or in block 248 that the application has recently been updated, or in block 252 that the user does not request updates, the routine continues to block 261 to present one or more information pages to the user that include information about one or more of the available coupons, such as in accordance with the sorted manner. In block 262, the routine then receives an indication that the user selects an indicated coupon to redeem, and in block 264 the routine proceeds to update the displayed information to show one or more merchant locations at which the coupon may be redeemed, such as locations near a current location of the device/user. In block 266, the routine receives an indication that the user has selected or verified a merchant location at which to redeem the coupon, and at block 268 determines whether the mobile device is within an applicable location radius, if any (e.g., as specified in a restriction for the coupon, as predetermined for the application, as specified by the user in prior preferences, etc.).

If the device is within the location radius or no such radius exists, the routine continues to blocks 271-276 to perform fraud detection activities that include attempting to automatically determine the validity of the coupon redemption for the selected coupon and the selected merchant location. As discussed in greater detail elsewhere, in some embodiments, the fraud detection activities are performed with respect to a particular transaction, such as at a time of or immediately prior to occurrence of the transaction (e.g., while the user and mobile device are at the physical location of the merchant). The coupon redemption validity determination may be based on determining a redemption confidence score and determining whether that score exceeds a predefined or otherwise determined threshold—as discussed in greater detail elsewhere, such a redemption confidence score may be determined in various manners and various embodiments, including by calculating probabilities or otherwise determining likelihoods for one or more of a variety of factors. In the illustrated routine, after block 271, the routine continues to block 272 to determine whether the initial validity determination has succeeded. If not, or if it is determined in block 268 that the device is not within any applicable location radius, the routine continues to block 281 to indicate that the coupon validity has failed, and in the illustrated embodiment provides a corresponding indication to the user. If it is instead determined in block 272 that the coupon redemption validity has been confirmed, the routine continues to block 282 to perform further redemption processing.

Alternatively, if the initial attempt to confirm the validity of redeeming the coupon fails but one or more other criteria are satisfied (e.g., a determined redemption confidence score is below a determined threshold, but is above a second lower threshold or is otherwise within a sufficient range of the threshold), the routine continues to block 274 to determine if additional corroborating information is available to raise the redemption confidence score above the threshold. If so, the routine continues to block 276 to request any such additional corroborating data. After block 276, the routine continues to block 271 to again attempt to determine the validity of the redemption of the coupon by performing one or more fraud detection techniques, such as to generate a revised redemption confidence score based on any additional data that is received for corroboration.

In block 282, one or more information pages are displayed on the mobile device confirming that the coupon redemption has been validated, allowing any corresponding monetary discount or other benefit associated with the coupon to be applied for the transaction. In the illustrated embodiment, in block 284, one or more personnel of the merchant view and approve the confirmation information on a mobile device, although in other embodiments such actions may not be performed. In block 286, the user optionally clicks to confirm the use of the coupon with the transaction in order to redeem it, and if so a unique transaction number is generated in block 288. In block 290 the routine determines whether the device has a network connection, and if not the routine continues to block 292 to store redemption data on the device until a network connection is available. Alternatively, if the network connection is available, the routine continues instead to block 281 to send a redemption message to the coupon server that includes the transaction number, with the redemption information being stored in a transaction log 283 of the coupon server. In block 285, the merchant is then credited with the transaction and the mobile device and user are also credited with the transaction, and in block 287 transaction information is made available to the merchant, such as via one or more web pages. In addition, in some embodiments, the routine may in block 291 send a transaction message to one or more remote computer systems, such as systems associated with a vendor of a product involved in the transaction and/or to a computing system of the merchant, with a confirmation message and data being sent to the mobile device in block 293. After blocks 292 or 293, the routine continues to block 294 to display one or more information pages to the user on the mobile device confirming that the transaction has been completed along with application of the redeemed coupon. After blocks 287 and 294, the routine ends.

It will be appreciated that the routine may include more or less operations in other embodiments.

Embodiments of methods for delivering coupons based upon location data provided by a client application, comprising the steps performed by the server data processing system of: (1) storing a set of location-specific coupons and location-specific merchants; (2) receiving a mobile device-originated request for coupons available for a specific location, the request including a string of information enabling the server to identify the location requested by the client application; (3) determining, via a set of algorithms, matching coupons and matching merchants for a given location; (4) dynamically restricting the use of certain coupons by a series of variables, e.g., client device ID, user ID, time of day, number of coupons already redeemed; and (5) transmitting both the appropriate coupons and merchant locations to the client application.

In certain embodiments of methods, the geographic location data string is provided by a Global Positioning System (GPS) device coupled to a client computer in which the first client application is resident. In certain embodiments of methods, the geographic location data string is provided by the client application transmitting to the server a cell tower identification number. In certain embodiments of methods, the geographic location data string is provided by a near field communication (NFC) receiver coupled to the client computer. In certain embodiments of methods, the geographic location data string is provided by a client application that receives a signal from a wireless local area network (WLAN) installed at or near the client application. In certain embodiments of methods, the geographic location data string is provided by a client application that receives a sound (or sonar-based signal) from a locally installed transmitter at the merchant location. In certain embodiments of methods, the geographic location data string is provided in a browser cookie. In certain embodiments of methods, the geographic location data string is provided in a hypertext markup language (HTML) form. In certain embodiments of methods, the geographic location data string is stored by and provided by at a third party server. In certain embodiments of methods, the geographic location data string is provided by a geographic location data previously stored by the client application.

In certain embodiments of methods, the set of location-specific elements are stored at a third party server. In certain embodiments of methods, the geographic location data string is entered manually by the user using a client application. In certain embodiments of methods, the client application is a web browser running on a mobile device. In certain embodiments of methods, the client application is a native application running on a mobile device.

Embodiments of computer program products may be stored in a computer-readable storage medium and executable by a data processing system for identifying and transmitting coupons and comprise instructions for performing steps of receiving, by a server data processing system, a request initiated by a client application for coupons appropriate for a specific location, the request including a geographic location data string identifying a location of the client application, the instructions and algorithms for determining which coupons are appropriate for a specific location, the instructions and algorithms for matching such coupons to the merchant locations nearest the physical location of the client application where such coupons may be redeemed, and the instructions for transmitting both the appropriate coupons and merchant locations to the client application. The set of coupons offered may also be dynamically restricted by variables such as client device ID, user ID, time of day, or other information stored by the client application.

Embodiments of computer program products stored in a computer-readable storage medium and executable by a data processing system on the client device for displaying the appropriate coupons received from the server including instructions for performing a step of serving the customized display page and offering the user to select the coupon(s) that are desired to be redeemed at the given merchant location.

Embodiments of computer program products may further include instructions for transmitting to the server the coupons that the user would like to redeem.

Embodiments of methods for authenticating whether a couponing transaction proposed by a client application is an authentic transaction based upon the location of the client application, according to an algorithm designed to determine the probability that a given user is actually at the given merchant location, may include the steps performed by the server data processing system of: 1) requesting from a client device a string of information enabling the server to identify the location of the mobile device running the client application; 2) determining via a set of algorithms the probability that the mobile device is at a given merchant; 3) matching this probability to any specified security restrictions or other criteria for a given coupon; and 4) determining whether the probability matches or exceeds any specified tolerance for authenticating the couponing transaction.

Embodiments of methods for authenticating whether a couponing transaction proposed by a client application is an authentic transaction may include a geographic location data string is provided by a Global Positioning System (GPS) device coupled to a client computer in which the first client application is resident.

Embodiment of methods for authentication whether a couponing transaction proposed by a client application is an authentic transaction may include a merchant identification string embodied within a Wi-Fi transmitter provided by the coupon redemption system that is specific to a given merchant location.

Embodiments of methods for authenticating whether a couponing transaction proposed by a client application is an authentic transaction may include a geographic location data string is provided by the client application transmitting to the server a cell tower identification number.

Embodiments of methods for authenticating whether a couponing transaction proposed by a client application is an authentic transaction may include a geographic location data string is provided by a near field communication (NFC) receiver coupled to the client computer.

Embodiments of methods for authenticating whether a couponing transaction proposed by a client application is an authentic transaction may include a geographic location data string provided by a client application that receives a signal from a wireless local area network (WLAN) installed at or near the client application.

Embodiments of methods for authenticating whether a couponing transaction proposed by a client application is an authentic transaction may include a geographic location data string provided by a client application that receives a sound (or sonar-based signal) from a locally installed transmitter at the merchant location.

Embodiments of methods for authenticating whether a couponing transaction proposed by a client application is an authentic transaction may include a geographic location data string provided in a browser cookie.

Embodiments of methods for authenticating whether a couponing transaction proposed by a client application is an authentic transaction may include a geographic location data string provided in a hypertext markup language (HTML) form.

Embodiments of methods for authenticating whether a couponing transaction proposed by a client application is an authentic transaction may include a geographic location data string stored by and provided by a third party server.

Embodiments of methods for authenticating whether a couponing transaction proposed by a client application is an authentic transaction may include a geographic location data string provided by a geographic location data previously stored by the client application.

Embodiments of methods for authenticating whether a couponing transaction proposed by a client application is an authentic transaction may include location-specific elements stored at a third party server.

Embodiments of methods for authenticating whether a couponing transaction proposed by a client application is an authentic transaction may include a geographic location data string entered manually by the user using a client application.

Embodiments of methods for authenticating whether a couponing transaction proposed by a client application is an authentic transaction may include a client application that is a native application running on a mobile device.

Embodiments of methods for authenticating whether a couponing transaction proposed by a client application is an authentic transaction may include a client application that is a web browser running on a mobile device.

Embodiments of methods for authenticating whether a couponing transaction proposed by a client application is an authentic transaction may include an algorithm for authenticating the couponing transaction that is enhanced by the use of non-location data such as the user ID, device ID, merchant ID, the expected availability of a given product at a given merchant.

Embodiments of methods for authenticating whether a couponing transaction proposed by a client application is an authentic transaction may include an algorithm for authenticating the couponing transaction that is enhanced by the use of redemption and attempted redemption data for a given coupon and/or by historical fraud data for the merchant and for similar coupons.

Embodiments of computer program products may be stored in a computer-readable storage medium and executable by a data processing system for determining whether to allow the redemption of a given transaction or not based upon the probability that a given transaction is a valid, non-fraudulent transaction. Such algorithms may consist of subroutines for determining a range of variables, including (but not limited to) the probability that the user is actually at the identified merchant location, the probability the user is actually purchasing a given product, the probability that the given client mobile device has been uniquely identified, the probability that the user is the user identified by the client application and the probability the given coupon is being redeemed in accordance with the instructions for its proper redemption.

Certain embodiments of computer program products may include instructions for requesting from the client application additional information to authenticate the transaction. Such additional information may include the request of a range of additional information from the client application (and if appropriate the user or merchant) corroborating the authenticity of the transaction. Such information may include (but is not limited to): specific numbers from a given product's UPC code, a recent photograph (including time stamp and GPS co-ordinates) of the product, a recent photograph (including time stamp and GPS co-ordinates) of the merchant location, a recent photograph (including time stamp and GPS co-ordinates) of the user, information from a location-specific QR code displayed by the merchant, a unique code number provided by the merchant, and/or identifying credentials from the user (such as a driving license, credit card or passport).

Certain embodiments of computer program products may further include instructions for logging (if appropriate) the redemption of the coupon(s), including the generation of a unique transaction identifying number and logging against the transaction (as appropriate) the merchant ID, the client device ID and user ID.

Certain embodiments of computer program products may further include instructions for crediting the merchant, the mobile device and/or user with the coupon redemption transaction, including the monetary amount of the transaction.

Certain embodiments of computer program products may further include instructions for transmitting a verification message to the client application, including the monetary amount of the transaction, unique transaction identifying number, the user ID, the merchant ID and a EAN-13 or QR code that may be scanned by the merchant's EPOS system so that the merchant may reconcile the transaction locally on the merchant's accounting system.

Certain embodiments of computer program products may also be able to look up the appropriate mobile phone number and/or email address for a given merchant and transmit to the merchant, via an SMS message or email message, confirming information.

Embodiments of computer program products may be stored in a computer-readable storage medium and executable by a data processing system on the client device with instructions for displaying to the user and merchant the transaction confirmation information according to instructions for transmitting a verification message to the client application, including the monetary amount of the transaction, unique transaction identifying number, the user ID, the merchant ID and a EAN-13 or QR code that may be scanned by the merchant's EPOS system so that the merchant may reconcile the transaction locally on the merchant's accounting system.

It will also be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, it will be appreciated that in other embodiments the operations may be performed in other orders and in other manners. It will also be appreciated that the data structures discussed above may be structured in different manners, including with respect to database data structures and Web page data structures, such as by having a single data structure split into multiple data structures or by having multiple data structures consolidated into a single data structure. Similarly, in some embodiments, illustrated data structures may store more or less information than is described, such as when other illustrated data structures instead lack or include such information respectively, or when the amount or types of information that is stored is altered.

As discussed above, embodiments provide systems, program products, and methods for enhanced coupon delivery and redemption that does not involve a merchant installing new transaction processing or transmission equipment, would not involve the merchant re-programming software, and would not involve the use of third-party terminals or networks to facilitate coupon redemption. Embodiments further provide an enhanced coupon delivery and redemption process that delivers and redeems coupons independently of any transaction processing or transmission hardware or software installed at a merchant site and in real time. By providing electronic coupon delivery and redemption in real time, the ability for the system to identify and deny couponing transactions suspected of coupon mis-redemption and mal-redemption are enhanced.

An embodiment provides a mobile telecommunications device in communication with a coupon server over a communications link for receiving electronic coupons from the coupon server and redeeming electronic coupons in a non-electronic consumer transaction with a merchant.

Embodiments providing a mobile telecommunications device may further comprise a processor and a non-transitory memory positioned in communication with the processor to store computer program products therein. Embodiments providing a mobile telecommunications device may also comprise a database to store a plurality of merchant records, a plurality of electronic coupon records, a plurality of historical transaction records, and a plurality of product records. Embodiments providing a mobile telecommunications device may also comprise a touch screen display to present coupon information, product information, and merchant information to a user and to receive from a user selections with respect to the coupon information, product information, and merchant information.

Embodiments providing a mobile telecommunications device may further comprise a global positioning system transceiver to receive positioning information for the mobile telecommunications device from a satellite in earth orbit. Embodiments providing a mobile telecommunications device may also comprise a radio-frequency transceiver to communicate with a coupon server over a communications link for receiving electronic coupons and redeeming electronic coupons. Embodiments providing a mobile telecommunications device may also comprise an input/output unit in communication with the global positioning system transceiver, the touch screen display, the database, the radio-frequency transceiver, and the processor.

Embodiments providing a mobile telecommunications device may comprise a first computer program product stored in the non-transitory memory and operable on the processor to define an update module. The update module may have a set of instructions comprising synchronizing one or more records of the database with the coupon server.

Embodiments providing a mobile telecommunications device may comprise a second computer program product stored in the non-transitory memory and operable on the processor to identify electronic coupons that may be redeemed to define an coupon delivery module. The coupon delivery module may have a set of instructions comprising determining geographic coordinates of the mobile telecommunications device responsive to one or more of the following: positioning information received through the global positioning system transceiver and cell tower positioning information received through the radio-frequency transceiver.

Embodiments providing a coupon delivery module may have a set of instructions further comprising determining one or more proximate merchant locations of the plurality of merchant records responsive to the geographic coordinates of the mobile telecommunications device and responsive to coordinates data for one or more of the merchant records.

Embodiments providing a coupon delivery module may have a set of instructions further comprising determining one or more proximate electronic coupons of the plurality of electronic coupon records responsive to the one or more proximate merchant locations and responsive to merchant locations data for one or more of the electronic coupon records.

Embodiments providing a coupon delivery module may have a set of instructions further comprising determining one or more available electronic coupons of the one or more proximate electronic coupons responsive to restriction data for one or more of the proximate electronic coupons and responsive to user information for the user of the mobile telecommunications device.

Embodiments providing a coupon delivery module may have a set of instructions further comprising generating a coupon selection field for display at the touch screen of the mobile telecommunications device responsive to coupon data for the one or more proximate coupons so that the user may select one of the proximate coupons to define a user-selected coupon.

Embodiments providing a coupon delivery module may have a set of instructions further comprising generating a merchant selection field for display at the touch screen of the mobile telecommunications device responsive to receiving a user-selected coupon, responsive to the merchant locations data for the user-selected coupon, and responsive to the geographic coordinates of the mobile telecommunications device so that the user may select one of the one or more proximate merchants to define a user-selected merchant, and

Embodiments providing a coupon delivery module may have a set of instructions further comprising generating a merchant confirmation field for display at the touch screen of the mobile telecommunications device responsive to receiving a user-selected merchant and responsive to merchant data for the user-selected merchant so that the user and an a representative of the user-selected merchant may confirm that a discounted non-electronic consumer transaction is contemplated between the user and the user-selected merchant, the discounted non-electronic consumer transaction being discounted discount in the amount of a user value, the user value being included in the coupon data for the user-selected coupon.

Embodiments providing a mobile telecommunications device may comprise third computer program product stored in the non-transitory memory and operable on the processor to redeem electronic coupons to define an coupon redemption module.

Embodiments providing a coupon redemption module may have a set of instructions further comprising determining a confidence score with respect to the non-electronic consumer transaction confirmed to be contemplated between the user and the user-selected merchant, the confidence score being a weighted product of a plurality of component confidence probabilities for each of a location probability, a user probability, a coupon mis-redemption probability, and a coupon mal-redemption probability, the weighted product being weighted according to a predefined weight corresponding to each of the plurality of component confidence probabilities, each of the component confidence probabilities being determined responsive to one or more of the geographic coordinates of the mobile telecommunications device, the plurality of electronic coupon records, the plurality of historical transaction records, and the plurality of product records.

Embodiments providing a coupon redemption module may have a set of instructions further comprising disallowing redemption of the user-selected coupon at the user-selected merchant if the confidence score is below a predefined threshold.

Embodiments providing a coupon redemption module may have a set of instructions further comprising generating a successful transaction record if the confidence score is above the predefined threshold, the successful transaction record having a unique transaction identifier.

Embodiments providing a coupon redemption module may have a set of instructions further comprising generating proof of the successful transaction for display at the touch screen of the mobile telecommunications device responsive to generating the successful transaction record, the proof of the successful transaction including the unique transaction identifier and coupon data for the user-selected coupon.

Embodiments providing a coupon redemption module may have a set of instructions further comprising transmitting the successful transaction record to the coupon server over the communication link so that the coupon server may credit an account of the user-selected merchant in the amount of a merchant value, the merchant value being included in the coupon data for the user-selected coupon.

From the foregoing it will be appreciated that, although specific embodiments have been described herein for purposes of illustration, various modifications may be made without deviating from the spirit and scope of the disclosure. In addition, while certain aspects are presented below in certain claim forms, the inventors contemplate the various aspects in any available claim form. For example, while only some aspects of the disclosure may currently be recited as being embodied in a computer-readable medium, other aspects may likewise be so embodied.

What is claimed is:

1. A computer-implemented method comprising:
receiving, by one or more software modules executing on a mobile device, information about a coupon selected by a user of the mobile device for use in a non-electronic transaction at a physical location of an indicated merchant;
determining, by the one or more executing software modules, a redemption confidence score corresponding to validity of redeeming the coupon for the non-electronic transaction, the determining of the redemption confidence score occurring while the user and the mobile device are at the physical location of the indicated merchant and being performed without using any information from any personnel of the indicated merchant or from any electronic devices at the physical location other than the mobile device, the determining of the redemption confidence score including calculating and combining probabilities for each of a plurality of factors that include a determined current location of the user being the physical location of the indicated merchant and that include multiple of: a determined current identity of an operator of the mobile device being the user, the coupon being mis-redeemed based on being determined to be inapplicable for use with the non-electronic transaction, and the coupon being mal-redeemed based on it being determined that the redeeming of the coupon occurs without the non-electronic transaction actually occurring; and
if the determined redemption confidence score is above a determined threshold, providing, by the one or more executing software modules, an indication of the validity of the redeeming of the coupon for the non-electronic transaction.

2. The method of claim 1 wherein the providing of the indication of the validity of the redeeming of the coupon for the non-electronic transaction includes displaying information to the user on the mobile device regarding the validity of the redeeming of the coupon for the non-electronic transaction and is performed without initiating any interactions with any personnel of the indicated merchant or with any electronic devices at the physical location other than the mobile device, to enable the user to confirm eligibility for a benefit associated with the coupon for the transaction.

3. The method of claim 1 wherein the providing of the indication of the validity of the redeeming of the coupon for the non-electronic transaction includes providing information to at least one of one or more personnel of the indicated merchant and of one or more electronic devices of the indicated merchant, to enable the merchant to confirm eligibility to provide the user with a benefit associated with the coupon for the transaction.

4. The method of claim 1 further comprising, if the determined redemption confidence score is not above the determined threshold, providing, by the one or more executing software modules, an indication of a lack of the validity of the redeeming of the coupon for the non-electronic transaction.

5. The method of claim 1 further comprising, if the determined redemption confidence score is not above the determined threshold:
querying, by the one or more executing software modules, the user to provide indicated information that is accessible at the physical location of the indicated merchant; and
confirming the validity of the redeeming of the coupon for the non-electronic transaction if the user successfully provides the indicated information.

6. The method of claim 1 wherein the determining of the redemption confidence score includes calculating a first probability that the determined current location of the user is the physical location of the indicated merchant, the calculating of the first probability including automatically determining an estimated current location of the user based on at least one of use of automated location determination capabilities and of obtaining location information from the user.

7. The method of claim 6 wherein the determining of the redemption confidence score further includes calculating a second probability that the operator of the mobile device is the user, the calculating of the second probability including automatically determining a likely current identity of the operator of the mobile device based at least in part on prior authentication activities performed by the operator of the mobile device.

8. The method of claim 7 wherein the determining of the redemption confidence score further includes:
calculating an additional probability that the coupon is being mis-redeemed, the calculating of the additional probability including automatically determining a likelihood that the coupon is inapplicable for use with the non-electronic transaction based at least in part on historical activities involving at least one of the user and the indicated merchant;
determining a weighting for each of the calculated first, second and additional probabilities; and
performing the combining of the probabilities by combining the calculated first, second and additional probabilities in a manner based on the determined weighting for each of the calculated first, second and additional probabilities.

9. The method of claim 7 wherein the determining of the redemption confidence score further includes:
calculating an additional probability that the coupon is being mal-redeemed, the calculating of the additional probability including automatically determining a likelihood that the redeeming of the coupon occurs without the non-electronic transaction actually occurring based at least in part on historical activities involving the indicated merchant;
determining a weighting for each of the calculated first, second and additional probabilities; and
performing the combining of the probabilities by combining the calculated first, second and additional probabilities in a manner based on the determined weighting for each of the calculated first, second and additional probabilities.

10. The method of claim 1 wherein the mobile device is at least one of a smartphone, a navigation device and a mobile computer, and wherein the method further comprises, before the receiving of the information about the coupon selected by the user of the mobile device:
receiving, by the one or more software modules, information about a plurality of coupons and about a plurality of merchants, at least some of the plurality of coupons each having one or more restrictions related to use of the coupon, and at least some of the plurality of merchants each having an associated physical location;
determining, by the one or more software modules, and for each of one or more of the at least some coupons, that the one or more restrictions for the coupon allow current use by the user of the coupon;
presenting, by the one or more software modules, information to the user on the mobile device indicating the one or more coupons, and receiving an indication of a selection by the user of one of the one or more coupons;
determining, by the one or more software modules, and for each of one or more of the at least some merchants, that the selected one coupon is available for use at the merchant and that the associated physical location of the merchant is within a determined distance of the determined current location of the user; and
presenting, by the one or more software modules, information to the user on the mobile device indicating the one or more merchants, and receiving an indication of a selection by the user of one of the merchants;
wherein the selected one merchant is the indicated merchant, and wherein the selected one coupon is the coupon selected by the user of the mobile device for use in the non-electronic transaction.

11. A non-transitory computer-readable medium whose contents configure a computing system to perform a method, the method comprising:
receiving, by the configured computing system, information about a coupon indicated by a user of a mobile device for use in a transaction at a physical location of a merchant;
determining, by the configured computing system, a redemption confidence score corresponding to validity of redeeming the coupon for the transaction, the determined redemption confidence score being based on a combination of multiple determined likelihoods that include at least one of: a determined likelihood of the user being at the physical location of the merchant for the transaction, a determined likelihood of accurately identifying at least one of the mobile device and the user of the mobile device, a determined likelihood of the coupon being mis-redeemed based on being inapplicable for use with the transaction, and a determined likelihood of the coupon being mal-redeemed based on the transaction not actually occurring; and
providing, by the configured computing system, an indication of the validity of the redeeming of the coupon for the transaction in response to the determined redemption confidence score exceeding a threshold.

12. The non-transitory computer-readable medium of claim 11 wherein the configured computing system is the mobile device of the user and is executing one or more software modules, wherein the coupon and the merchant are indicated by the user via the mobile device, wherein the multiple determined likelihoods are each an automatically calculated probability, and wherein the determining of the redemption confidence score is performed without performing any interactions with any personnel or electronic devices of the merchant at the physical location.

13. The non-transitory computer-readable medium of claim 11 wherein the method further comprises obtaining an indication of a wireless signal received by the mobile device from a transmitting device, and wherein the determining of the redemption confidence score includes determining the likelihood that a location of the user during the transaction is the physical location of the merchant based at least in part on the wireless signal received by the mobile device.

14. The non-transitory computer-readable medium of claim 13 wherein the configured computing system is part of a coupon redemption service, and wherein the transmitting device is a wireless networking device at the physical location of the merchant that transmits an identifier associated with the merchant by the coupon redemption service.

15. The non-transitory computer-readable medium of claim 11 wherein the computer-readable medium is a memory of the configured computing system, and wherein the contents are instructions that when executed program the configured computing system to perform the method.

16. A system, comprising:
one or more processors of one or more computing systems; and
one or more modules that are configured to, when executed by at least one of the one or more processors, determine validity of redeeming a coupon at a physical location of a merchant, the determining of the validity including:
receiving information about an indicated use of the coupon by a user of a mobile device for a transaction at the physical location of the merchant;
determining a redemption confidence score corresponding to validity of redeeming the coupon for the transaction based on a combination of multiple determined likelihoods, the multiple determined likelihoods including a determined likelihood of the user being at the physical location of the merchant for the transaction and including at least one of: a determined likelihood of accurately identifying at least one of the mobile device and the user of the mobile device, a determined likelihood of the coupon being mis-redeemed based on being inapplicable for use with the transaction, and a determined likelihood of the coupon being mal-redeemed based on the transaction not actually occurring; and
providing an indication of the validity of the redeeming of the coupon for the transaction in response to the determined redemption confidence score exceeding a threshold.

17. The system of claim 16 wherein the one or more computing systems include the mobile device of the user, wherein the coupon and the merchant are indicated by the user via the mobile device, wherein the multiple determined likelihoods are each an automatically calculated probability, and wherein the determining of the redemption confidence score is performed without performing any interactions with any personnel or electronic devices of the merchant at the physical location.

18. The system of claim 16 wherein the one or more computing systems include a configured computing system that is remote from the mobile device of the user and is part of a coupon redemption service, and wherein the determined likelihood of the user being at the physical location of the merchant for the transaction is based at least in part on a wireless signal received by the mobile device from a wireless networking device at the physical location of the merchant that transmits a unique identifier associated with the merchant by the coupon redemption service.

19. The system of claim 16 wherein the one or more modules include software instructions for execution by at least one of the one or more processors.

20. The system of claim 16 wherein the one or more modules consist of one or more means for performing the determining of the validity of redeeming the coupon at the physical location of the merchant.

21. A computer-implemented method comprising:
receiving, by one or more software modules executing on a mobile device, information about a coupon selected by a user of the mobile device for use in a non-electronic transaction at a physical location of an indicated merchant;
determining, by the one or more executing software modules, a redemption confidence score corresponding to validity of redeeming the coupon for the non-electronic transaction, the determining of the redemption confidence score occurring while the user and the mobile device are at the physical location of the indicated merchant and being performed without using any information from any personnel of the indicated merchant or from electronic devices at the physical location, the determining of the redemption confidence score including:
calculating a first probability that a current location of the user is actually the physical location of the indicated merchant, the calculating of the first probability being based at least in part on use of automated location determination capabilities of the mobile device;
calculating a second probability that an identity of an operator of the mobile device is actually the user, the calculating of the second probability being based at least in part on prior authentication activities performed by the operator of the mobile device;
calculating a third probability that the coupon is being mis-redeemed due to the coupon being invalid for use with the non-electronic transaction, the calculating of the third probability being based at least in part on historical activities involving at least one of the user and the indicated merchant;
calculating a fourth probability that the coupon is being mal-redeemed due to the redeeming of the coupon occurring without the non-electronic transaction actually occurring, the calculating of the fourth probability being based at least in part on historical activities involving the indicated merchant;
determining weightings for the calculated first, second, third and fourth probabilities based at least in part on confidence values of the calculated first, second, third and fourth probabilities; and
generating the determined redemption confidence score by combining the calculated first, second, third and fourth probabilities in a manner based on the determined weightings;
determining, by the one or more executing software modules, that the determined redemption confidence score exceeds a predefined threshold; and
in response to the determining that the determined redemption confidence score exceeds the predefined threshold, providing, by the one or more executing software modules, confirmation of the validity of the redeeming of the coupon for the non-electronic transaction, to enable the user to obtain a monetary benefit associated with the coupon for the transaction.

22. The method of claim 21 wherein the providing of the confirmation of the validity of the redeeming of the coupon for the non-electronic transaction is performed before completion of the non-electronic transaction and includes displaying information on the mobile device regarding the confirmation, to enable the user and personnel of the indicated merchant to confirm eligibility of the user to obtain the monetary benefit for the transaction.

23. The method of claim 21 further comprising, before the determining of the redemption confidence score, initiating the prior authentication activities, the prior authentication activities including:
obtaining secret information from the operator of the mobile device that is associated with the user;
obtaining at least one of a telephone call from the mobile device to an indicated telephone number and an electronic message sent from the mobile device to an indicated electronic address, to enable unique information associated with the mobile device to be identified; and
associating the user with the mobile device based at least in part on the obtained unique information and the obtained secret information.

24. The method of claim 23 further comprising storing a cookie on the mobile device that includes identifying information associated with at least one of the user and the mobile device, and transmitting the stored cookie to a remote coupon server as part of interactions between the mobile device and the coupon server.
